(19) United States
(12) Patent Application Publication
(10) Pub. No.: US 2007/0002833 A1
(43) Pub. Date: Jan. 4, 2007

(54) Method, system and apparatus for assigning and managing IP addresses for wireless clients in wireless local area networks (WLANs)

(75) Inventor: Zeljko Bajic, San Jose, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/171,131

(22) Filed: Jun. 30, 2005

(51) Int. Cl. H04L 12/66

(52) U.S. Cl. 370/352

(57) ABSTRACT

Techniques are provided IP address assignment and management in a wireless network. Such a wireless network can comprise a plurality of wireless clients, a registration server, a plurality of wireless switches each being configured to support a particular subnet. Each wireless client can generate a Dynamic Host Configuration Protocol (DHCP) request for an Internet Protocol (IP) address when the client either powers up in of moves to a new subnet, 802.11 authenticates and associates and 802.1x authenticates. The wireless switches can communicate with the registration server over an IP tunnel. For example, each wireless switch can receive the DHCP requests from wireless clients associated with the subnet of the wireless switch, and forward the DHCP requests to the registration server. The registration server can receive the forwarded DHCP requests, and assign IP addresses to the wireless clients based on the forwarded DHCP requests.

### TECHNICAL FIELD OF THE INVENTION

The present invention generally relates to computer networks and, more particularly, to methods, systems and apparatus for assigning IP addresses to wireless clients in a Wireless Local Area Network (WLAN).

### BACKGROUND OF THE INVENTION

WLANs, based on the IEEE 802.11 standards, have conventionally been used for ordinary Internet services such as web browsing, file transfers and electronic mail. However, with the emerging usage of real time multimedia applications such as voice over IP (VoIP) telephony, these same WLAN networks can also be used as infrastructure for enabling such applications. WLANs can give clients the ability to “roam” or physically move from place to place without being connected by wires. In the context of WLANs the term “roaming” describes the act of physically moving between access points (APs). One issue in the area of WLANs relates to the ability to maintain an IP-connection while roaming.

FIG. 1 is a block diagram of a conventional wireless local area network (WLAN). The WLAN 1 of FIG. 1 includes wireless clients 2, 4, a first subnet (A) 10, a wireless switch 12, access points (APs) 14, 16, a second subnet (B) 20, a wireless switch 22, access points (APs) 24, 26 and layer 3 routers 34, 36. The router 34 is coupled to the wireless switch 12. The wireless switch 12 supports the first subnet (A) 10 and is coupled to the access points (APs) 14, 16. The access points (APs) 14, 16 have IP addresses within the first subnet (A) 10. The router 36 is coupled to the wireless switch 22. The wireless switch 22 supports the second subnet (B) 20 and is coupled to the access points (APs) 24, 26. The access points (APs) 24, 26 have IP addresses within the second subnet (B) 20. The clients 2, 4 are wireless devices which physically move around the WLAN 1, and communicate with an IP network via the access points (APs) 14, 16 and access points (APs) 24, 26, respectively.

FIG. 1 illustrates the concept of layer 2 roaming and the concept of layer 3 roaming in the WLAN. A layer 2 network is defined as a single IP subnet and broadcast domain, such as the first subnet (A) 10, while a layer 3 network is defined as the combination of multiple IP subnets and broadcast domains, such as the first subnet (A) 10 and the second subnet (B) 20.

Layer 2 refers to the data link layer of the Open Systems Interconnection (OSI) communication model. The data link layer is concerned with moving data across the physical links in the network. In a network, the switch is a device that redirects data messages at the layer 2 level, using the destination Media Access Control (MAC) address to determine where to direct the message. In the context of the IEEE-802 LAN standards, the data link layer contains two sublayers called the Media Access Control (MAC) sublayer and the Logical Link Control (LLC) sublayer. The data link layer ensures that an initial connection has been set up, divides output data into data frames, and handles the acknowledgements from a receiver that the data arrived successfully. The data link layer also ensures that incoming data has been received successfully by analyzing bit patterns at special places in the frames. In a local area network (LAN) or other network, the Media Access Control (MAC) address is a host computer's unique hardware number, and on an Ethernet LAN the MAC address is an Ethernet address. When a computer or other host connects to the Internet, a correspondence table relates the hosts IP address to the host's physical (MAC) address on the LAN. The MAC address is used by the Media Access Control sublayer of the Data-Link Layer (DLC) of telecommunication protocols. There is a different MAC sublayer for each physical device type.

Layer 2 roaming occurs when a client moves far enough away from its AP such that its radio associates with a different AP in the same subnet. The client disconnects from one Access Point (AP) and re-connects to another AP in the same subnet (broadcast domain) where several APs use the same Service Set Identifier (SSID). An SSID is a sequence of alphanumeric characters (letters or numbers) which specify the name of a wireless local area network (WLAN). All wireless devices on a WLAN must employ the same SSID in order to communicate with each other. The SSID on wireless clients can be set either manually, by entering the SSID into the client network settings, or automatically, by leaving the SSID unspecified or blank. Generally, there are two types of SSIDs. A Basic Service Set Identification (BSSID) is the identifying name of an ad-hoc wireless network with no access points. An Extended Service Set Identification (ESSID) is used in infrastructured wireless networks, which include access points, as the identifying name of a wireless network. The ESSID is the identifying name of a wireless access point. It allows one wireless network to be clearly distinguishable from another. A client continuously listens to nearby APs and can decide to roam if it finds an AP with the same SSID and a stronger signal or is experiencing too much loss with the current AP. To initiate a layer 2 roam, the client sends an associate (or reassociate) request to the new AP. It may disassociate from the old AP, or the old AP may notice the client is no longer there.

IEEE's 802.11f Inter Access Point Protocol (IAPP) addresses roaming between Access Points (APs) inside client's home subnet and assures constant IP-connectivity in this case. With layer 2 roaming, APs inside a given subnet share the same Extended Service Set (ESS), and although the physical point of attachment (the AP) changes, the client is still served by the same Access Router. Because the original and the new AP offer coverage for the same IP subnet, the device's IP address is still valid after the roam and can remain unchanged. For example, when the roams within the first subnet (A) 10, the IP address of the client will remain the same.

After the client successfully roams, LAN traffic for the client can be relayed through the new AP. However, because the scalability of subnets is limited by the number of APs and clients that can be supported within a given subnet, in some situations the client roams to a new AP in a different or foreign subnet supported by another wireless switch. Because the client cannot be identified by its original home IP address anymore, a new IP address is required for the routing the client's IP data. Consequently, any on-going connections can be disrupted and IP connectivity can be lost. For applications like wireless VoIP phones or streaming applications, this is not acceptable.

Layer 3 refers to the network layer of the Open Systems Interconnection (OSI) multilayered communication model. The network layer is concerned with knowing the address of the neighboring nodes in the network, selecting routes and quality of service, and recognizing and forwarding to the transport layer incoming messages for local host domains.

Layer 3 roaming occurs when a client moves from an AP within its home IP subnet, such as the first subnet (A) 10, to a new AP within a foreign IP subnet, such as the second subnet (B) 20. This foreign IP subnet has a different Basic Service Set (BSS) than the home IP subnet. The client disconnects from one AP and reconnects or re-associates with another foreign AP in a foreign IP subnet outside its home IP subnet. In this re-association, the client is supposed to be served by a different access router (through the foreign AP), which bares a different IP address, while the client itself preserves its original IP address. At that point, the client would no longer have an IP address and default gateway that are valid within the foreign IP subnet. Therefore, if no other protocol is implemented to address an L3 roam, the client will not able to send/receive IP packets from/to its current location. As a result, active IP sessions can be dropped because IP-connectivity is lost.

To prevent existing data sessions or voice calls from failing because the remote client can no longer reach the local client, processes called “IP handoff” or “L3 handover” can be used to preserve the IP traffic to/from the client after such re-association with the foreign AP. Because this process is not addressed by current IEEE nor Wi-Fi standards, important functions, such as preservation of the client's IP connectivity upon a layer 3 handover, have yet to be standardized.

Nevertheless, some vendors of WLANs have developed solutions which can allow layer 3 roaming to occur by providing mechanisms for a client to obtain a new IP address. For instance, if the client roams across a boundary between the first subnet (A) 10 and the second subnet (B) 20 and a Dynamic Host Configuration Protocol (DHCP) is enabled on the client, then the client can use DHCP to obtain a new IP address of the second subnet (B) 20. As used herein, the “Dynamic Host Configuration Protocol (DHCP)” refers to a protocol for assigning dynamic IP addresses to devices on a network. DHCP typically sends a new IP address when a computer is plugged into a different place in the network. This protocol allows a device to have a different IP address every time it connects to the network, and the device's IP address can even change while it is still connected. DHCP can also support a mix of static and dynamic IP addresses. DHCP uses the concept of a “lease” or amount of time that a given IP address will be valid for a computer. Using very short leases, DHCP can dynamically reconfigure networks in which there are more computers than there are available IP addresses.

However, layer 3 traffic re-routing requires more than updating MAC address tables and ARP caches. Many applications require persistent connections and drop their sessions as a result of inter-subnet roaming. Network layer devices such as routers and layer 3 switches must somehow be told to forward IP packets to the client's new subnet. To provide session persistence, mechanisms are needed to allow a client to maintain the same Layer 3 address while roaming throughout a multi-subnet network. Otherwise, many applications will timeout trying to reach the client's old IP and must be reconnect with the client's new IP.

One way to support layer 3 roaming in WLANs is via an open IETF standard called Mobile IP. Mobile IP provides one solution for handling the L3 movements of clients regardless of the underlying layer 2 technology.

In the context of Mobile IP, the client is referred to as a mobile node (MN). In the description that follows, these terms are used interchangeably. Mobile IP uses a Home Agent (HA) to forward IP packets to a Foreign Agent (FA) in the client's new subnet. The HA and FA advertise themselves using the ICMP Router Discovery Protocol (IRDP). The Foreign Agent periodically advertises its presence wirelessly and waits for a solicitation message from a roaming mobile node. When a Mobile IP-enabled client roams to a new subnet, it must discover and register itself with a nearby FA. The registration process for such a node is triggered by a wireless registration request (after the 802.11 association is completed) issued by the MN. The FA forwards that request to that client's original HA. Wired messages can then be exchanged between the HA and the FA as well as with binding table updates. An acknowledgment can then be sent wirelessly to the MN.

If the request is accepted, a tunnel is established between the HA and FA to relay incoming packets sent to the client's original IP address. The HA serves as the anchor point for communication with the wireless client. It tunnels packets, from Corresponding Nodes (CNs) towards the current address of the MN and vise versa. Outbound packets are routed back through the tunnel from the FA to HA, and then on to their destination.

Although Mobile IP preserves subnet connectivity for roaming clients, it can result in sub-optimal routing and longer roaming delay. As noted above, the wireless client must first regain over the air connectivity with its new FA before the Agent Discovery Phase is launched. This can result in considerable reconnection time which increases latency. Furthermore, the registration process involves wire line and wireless communication. The amount of packet loss and the significant delay introduced during these procedures make the method unsuitable for many WLAN applications, such as VoIP over 802.11 or streaming over 802.11.

Notwithstanding these advances, as new applications emerge and are implemented, such as VoIP over 802.11, changes to the WLAN deployment are required. For example, coverage-oriented deployments must move to capacity-oriented deployments characterized by low user to AP ratio and more APs in a given coverage area. The move to capacity-oriented deployments emphasizes the need for techniques that allow clients to roam across subnets and roaming domains.

IEEE 802.1X and 802.11 do not specify a mechanism for IP address assignment. In a typical WLAN, a layer 3 or IP device provides an IP addressing service and assigns IP addresses to the clients. For example, for each wireless switch in the WLAN, an external DHCP server can be provided which supports a single IP subnet associated with a particular wireless switch. This external DHCP server receives all DHCP requests broadcasted on a given subnet, and assigns IP addresses to all clients of that given subnet.

There is a need for layer 3 roaming techniques which can allow a client to roam across different IP subnets of a WLAN while preserving the client's original IP-connection and original IP address. It would be desirable if such techniques could allow the client to perform a seamless and smooth L3 handoff between APs of different IP subnets, while maintaining an active session without losing IP connectivity. It would be desirable if such techniques could enable routing of IP data to/from the client's current foreign subnet to their original IP address and home subnet even though the client is currently in a foreign subnet. It would also be desirable to provide layer 3 roaming techniques which can eliminate the need to re-key during re-authentication.

In some deployment scenarios, a WLAN will be deployed in a large area and supports a large number of clients on a number of wireless switches. Due to the location and distribution of the wireless switches, there can be an increased likelihood that one of the wireless switches will be assigned as the home wireless switch to a disproportionately large number or percentage of mobile clients in the WLAN. For example, a WLAN deployed at a park might have a number wireless switches. In this scenario, a first wireless switch might be located, for example, at a park, mall, stadium or other location where a large percentage of the clients will power on their 802.11 devices at the entrance. As a result the first wireless switch can become the home wireless switch of a large percentage of the clients such that it supports a disproportionately large number of the clients. When these clients roam the first wireless switch will remain as the home wireless switch for those clients, and the traffic to and from these clients will be tunneled back to first wireless switch indefinitely regardless of the client's location and proximity to other wireless switches in the WLAN. As a result, it is possible that the first wireless switch will get overloaded while some other wireless switches in the WLAN may be handling a relatively light load.

It would be desirable to provide techniques which allow the first wireless switch to determine that it should no longer remain as the home wireless switch for a certain client or clients when those clients move away from the first wireless switch. Techniques are needed to allow the first wireless switch to determine that it is no longer the best home wireless switch for a particular client or clients. Techniques are also needed to balance the number of clients assigned to a particular wireless switch such that the load on each of the wireless switches in the WLAN becomes more balanced.

Other desirable features and characteristics of the present invention will become apparent from the subsequent detailed description and the appended claims, taken in conjunction with the accompanying drawings and the foregoing technical field and background.

### SUMMARY OF THE INVENTION

According to one embodiment, techniques are provided for IP address assignment and management in a wireless network. Such a wireless network can comprise a plurality of wireless clients, a registration server, a plurality of wireless switches each being configured to support a particular subnet. Each wireless client can generate a Dynamic Host Configuration Protocol (DHCP) request for an Internet Protocol (IP) address when the client either powers up in of moves to a new subnet, 802.11 authenticates and associates and 802.1x authenticates. The wireless switches can communicate with the registration server over an IP tunnel. For example, each wireless switch can receive the DHCP requests from wireless clients associated with the subnet of the wireless switch, and forward the DHCP requests to the registration server. The registration server can receive the forwarded DHCP requests, and assign IP addresses to the wireless clients based on the forwarded DHCP requests.

### BRIEF DESCRIPTION OF THE DRAWINGS

The present invention will be described in conjunction with the following drawing figures, wherein like numerals denote like elements, and

FIG. 1 is a block diagram of a conventional wireless local area network (WLAN) which illustrates the concept of layer 2 roaming and the concept of layer 3 roaming in the WLAN;

FIG. 2 is a block diagram of a WLAN according to one exemplary embodiment which implements a registration server and a plurality of wireless switches;

FIG. 3 is a block diagram of a registration server according to one exemplary embodiment;

FIG. 4 is a block diagram of a wireless switch according to one exemplary embodiment;

FIG. 5 is a flow chart showing an exemplary method creating a mesh network of wireless switches according to one exemplary embodiment;

FIG. 6 is a flow chart showing an exemplary method for providing an active client list to a plurality of wireless switches according to one exemplary embodiment;

FIG. 7 is a block diagram of a WLAN according to one exemplary embodiment which implements a registration server and a plurality of wireless switches supporting a plurality of wireless clients;

FIG. 8 is a block diagram of an exemplary registration packet tunneled to the registration server by a wireless switch according to one embodiment;

FIG. 9 is a block diagram of an exemplary registration response packet tunneled to the wireless switch by the registration server according to one embodiment;

FIG. 10 is a block diagram of a WLAN according to another exemplary embodiment which implements a registration server and a plurality of wireless switches;

FIG. 11 is a block diagram of an exemplary DHCP registration packet tunneled to the registration server by a wireless switch according to one implementation;

FIG. 12 is a block diagram of an exemplary DHCP registration response packet tunneled to the wireless switch by the registration server according to one implementation;

FIG. 13 is a block diagram of a WLAN according to one exemplary embodiment which implements a registration server and a plurality of wireless switches including an original home wireless switch of a client;

FIG. 14 is a flow chart showing an exemplary method for WLAN load balancing according to one exemplary embodiment;

FIG. 15 is a flow chart showing a method for a home wireless switch to select one of a plurality of candidate wireless switches in a WLAN as a new home wireless switch for the first client according to one exemplary embodiment;

FIG. 16 is a flow chart showing another method for a home wireless switch to select one of a plurality of wireless switches as a new home wireless switch for the first client according to another exemplary embodiment;

FIG. 17 is a flow chart showing a method for tunneling traffic generated by a client to a new home wireless switch to according to one exemplary embodiment;

FIG. 18 is a block diagram of a WLAN according to one exemplary embodiment which implements a registration server and a home wireless switch supporting a first subnet and a visited wireless switch supporting a second subnet;

FIG. 19 is a flow chart showing an exemplary method for allowing a client, initially associated with a home wireless switch and having a client IP address from within a first subnet, to roam from the home wireless switch to a visited wireless switch configured to support a second subnet according to one exemplary embodiment;

FIG. 20 is a flow chart showing exemplary message exchanges between the home wireless switch which supports a first subnet and the visited wireless switch which supports a second subnet to allow the client to maintain a client IP address when the client roams to the second subnet according to one exemplary embodiment.

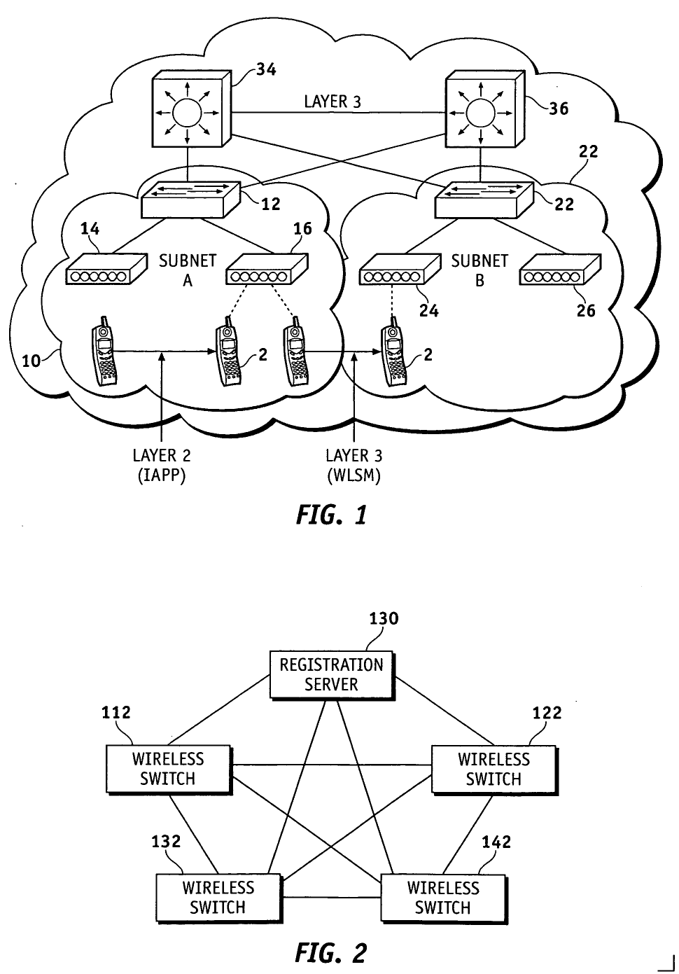

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. As used herein, the word “exemplary” means “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

Overview

A wireless network is provided comprising a plurality of wireless clients, a plurality of IP tunnels, a registration server, a plurality of wireless switches each being configured to support a particular subnet, and a plurality of external DHCP servers each being coupled to one of the wireless switches. As used herein, a “client” is a mobile device in a WLAN. The term “mobile device” can generally refer to a wireless communication device or other hardware with which an access network communicates. At a given time a mobile device may be mobile or stationary and can include devices that communicate through a wireless channel or through a wired channel. A mobile device may further be any of a number of types of mobile computing devices including but not limited to a laptop computer, a PC card, compact flash, external or internal modem, wireless or wireline phone, personal digital assistant (PDA) or mobile telephone handset.

Each wireless client can generate a Dynamic Host Configuration Protocol (DHCP) request for an Internet Protocol (IP) address when the client either powers up in moves to a new subnet, 802.11 authenticates and associates and 802.1x authenticates. The wireless switches can communicate with the registration server over one of the IP tunnels. For example, each wireless switch can receive the DHCP requests from wireless clients associated with the subnet of the wireless switch, and forward the DHCP requests to the registration server. The registration server can receive the forwarded DHCP requests, and assign IP addresses to the wireless clients based on the forwarded DHCP requests.

In one embodiment, the registration server comprises an IP address assignment module hosted at the registration server. The IP address assignment module can generate a pool of IP addresses from a plurality of sub-pools of IP addresses. Each sub-pool can include IP addresses supported by one of the subnets in the wireless network. For instance, in one implementation, the pool takes the form of a table. The IP address assignment module generates a table comprising a plurality of entries, where each entry of the table comprises: a wireless switch IP address and a sub-pool of IP addresses corresponding to the wireless switch IP address. The IP address assignment module can assign IP addresses, from the pool of IP addresses, to each of the wireless clients of the wireless network. The registration server may optionally include an IP address management module configured to manage the pool of IP addresses. For example, in one embodiment, the IP address assignment module can assign an IP address to a given wireless client from the sub-pool associated with the particular subnet the given wireless client is associated with. The IP address assigned to the given wireless client is associated with the particular subnet for that given wireless client.

In one exemplary implementation, the wireless switches comprise a first wireless switch which supports a first subnet and a second wireless switch which supports a second subnet. In this case, the pool of IP addresses may comprise a first sub-pool of IP addresses associated with the first wireless switch and the first subnet, and a second sub-pool of IP addresses associated with the second wireless switch and the second subnet. When a wireless client roams from a first wireless switch to a second wireless switch, the wireless client sends a DHCP request to the second wireless switch. A DHCP proxy module is provided in the second wireless switch can use the DHCP request to determine the MAC address of the wireless client, and determine if the second wireless switch already has a record for the wireless client based on the MAC address of that wireless client. The record includes authentication and association information for that wireless client. If the DHCP proxy module determines that the second wireless switch already has a record for the wireless client, then the second wireless switch sends a DHCP response back to the wireless client which reassigns the existing IP address of the wireless client to the wireless client. By contrast, if the DHCP proxy module determines that the second wireless switch does not have a record for the wireless client, then the second wireless switch registers the wireless client with the registration server by generating a registration packet and sending the registration packet to the registration server. This registration packet may comprise, for example, an IP tunnel header for sending the registration packet to the registration server, and client registration information associated with the wireless client. The client registration information is typically information which can be collected during 802.11 authentication/association and 802.1x authentication of the wireless client and may include, among other things, the wireless client's Media Access Control (MAC) address. The registration server can add the client registration information into an Active Client List (ACL), and can assign, among other things, home and visited wireless switches to the wireless client based on the wireless client registration information.

In one embodiment, the IP address assignment module comprises a dedicated DHCP server module hosted on the registration server, and the registration packet sent by the second wireless switch to the registration server further comprises a DHCP request from the wireless client encapsulated in the registration packet. This dedicated DHCP server module can assign an IP address to a given wireless client from the sub-pool associated with the particular subnet which the given wireless client is associated with. Thus, the IP address assigned to the given wireless client is associated with the particular subnet for that given wireless client. For example, the IP address assignment module can determine an IP address of the second wireless switch and assign a particular IP address to the wireless client from the second sub-pool of IP addresses associated with the second wireless switch and the second subnet.

The IP address assignment module generates a registration response packet in response to the DHCP request. Each registration response packet comprises an IP tunnel header and registration information about the wireless client assigned by the registration server. Alternatively, the registration response packet may comprise the IP tunnel header, the registration information about the wireless client, and a DHCP response encapsulated within the DHCP registration response packet by the IP tunnel header and the registration information. The registration information comprises a wireless client's IP address assigned to the wireless client by the registration server, a home wireless switch assigned to the wireless client by the registration server, and a visited wireless switch assigned to the wireless client by the registration server. The IP address assignment module sends or “tunnels” each registration response packet to the wireless switch which initially communicated the registration packet to the registration server. The wireless switch can determine the IP address of the wireless client based on registration response packet. The wireless switch can then transmit the DHCP response to the wireless client and at least part of the registration information to other wireless switches in the wireless network.

The external DHCP servers coupled to the wireless switches can receive DHCP requests from wired clients within a subnet of its corresponding wireless switch and can assign IP addresses to wired clients supported by a corresponding wireless switch of the DHCP server

Thus, embodiments of the present invention can provide methods and apparatus for assigning IP addresses to clients supported in multiple IP subnets of a WLAN, and managing the IP addresses assigned to those clients.

### EXEMPLARY EMBODIMENTS

FIG. 2 is a block diagram of a WLAN according to one exemplary embodiment which implements a registration server 130 and wireless switches 112, 122, 132, 142. As used herein, the term “WLAN” refers to a network in which a mobile user can connect to a local area network (LAN) through a wireless (radio) connection. The IEEE 802.11 standard specifies some features of exemplary wireless LANs.

As used herein, the term “packet” refers to a unit of data that is routed between an origin and a destination on a packet-switched network such as the Internet. When any file is sent from one place to another on the Internet, the Transmission Control Protocol (TCP) layer divides the file into “chunks” of an efficient size for routing. Each of these packets is separately numbered and includes the Internet address of the destination. The individual packets for a given file may travel different routes through the Internet. When they have all arrived, they are reassembled into the original file by the TCP layer at the receiving end. In the context of the User Datagram Protocol (UDP), it should be appreciated that the term “datagram” has a similar meaning to the term “packet.”

As used herein, the term “switch” refers to a device that channels incoming data from any of multiple input ports to the specific output port that will take the data toward its intended destination. A switch typically performs the data-link or layer 2 function and determines, from an IP address in each packet, which output port to use for the next part of its trip to the intended destination. The destination address generally requires a look-up in a routing table by a device known as a router. In some embodiments, the switch can function as an IP switch which may also perform network or layer 3 routing functions.

The registration server 130 and wireless switches 112, 122, 132, 142 can be coupled to each other via IP sockets or tunnels which the wireless switches 112, 122, 132, 142 create to the registration server 130. The wireless switches 112, 122, 132, 142 are coupled to each other by a mesh network of IP sockets or tunnels. As used herein, the term “tunneling” refers to the process of allowing two disparate networks to connect directly to one another when they normally would not or when they are physically disjointed. Tunneling is synonymous with encapsulation, and is generally done by encapsulating private network data and protocol information within public network transmission units so that the private network protocol information appears to the public network as data. A tunnel requires an entry point and an exit point. The entry point encapsulates the tunneled packets within another IP header. The new IP header might include some other parameters, but the basic function of the encapsulation header is to direct the packet to the tunnel endpoint. A packet received by the tunnel endpoint is stripped of the encapsulation header and forwarded to the client.

The registration server 130 is a network entity that can be implemented as dedicated hardware on an external high availability platform. For example, the registration server 130 might be implemented in a blade server. Alternatively, the registration server 130 can be implemented as a module hosted on two wireless switches.

The registration server 130 is used for registering wireless switches in the WLAN when the wireless switches join the WLAN. The registration server 130 has a first Internet Protocol (IP) address which is configured on every wireless switch in the WLAN. As used herein, the term “Internet Protocol (IP) address” refers to a layer 3 address, and can be a number which identifies each sender or receiver of information packets across the Internet. Each communication from a user on the Internet carries an IP address of the source and destination networks and the particular machine within the network associated with the user or host computer at each end. An IP address generally comprises an identifier of a particular network on the Internet and an identifier of the particular device (which can be a server or a workstation) within that network. In one implementation, the IP address is a 32-bit address comprising one part identifies the network with a network number and another part which identifies the specific machine or host within the network with a host number. Some of the bits in the machine or host part of the address can be used to identify a specific subnet. In this case, the IP address then contains three parts: the network number, the subnet number, and the machine number.

Each of the wireless switches 112, 122, 132, 142 has configuration information associated with it which can include, for example, an IP address and a list of subnets (IP domains) which the particular wireless switch supports. As used herein, the term sub-network or “subnet” refers to an identifiably separate part of a network. Typically, a subnet may represent all the machines at one geographic location, in one building, or on the same wireless local area network (WLAN). One standard procedure for creating and identifying subnets is described in Internet Request for Comments (RFC) 950.

Each of the wireless switches 112, 122, 132, 142 registers with the registration server 130 by communicating its configuration information to the registration server 130 and uses the IP address of the registration server 130 to create or open a first IP socket (tunnel) to the registration server 130. The wireless switches 112, 122, 132, 142 can periodically send update messages to each other. These update messages can include, for example, changes to the configuration information associated with each wireless switch.

The registration server 130 can use the configuration information to create an AWSL which includes a listing of each of the wireless switches 112, 122, 132, 142 in the WLAN. The registration server 130 sends the AWSL to each of the wireless switches 112, 122, 132, 142. Each of the wireless switches 112, 122, 132, 142 uses the AWSL to open a UDP/IP socket to each of the other wireless switches 112, 122, 132, 142. Once all of the wireless switches 112, 122, 132, 142 are coupled together via UDP/IP sockets and are coupled to the registration server 130 via IP sockets, the mesh network is complete. This mesh network changes dynamically as new switches are added (e.g., register with the registration server 130) or removed from the WLAN.

In one implementation, each of the wireless switches 112, 122, 132, 142 can send configuration information to each of the other wireless switches 112, 122, 132, 142. Alternatively, the registration server 130 can send the configuration information for each of the wireless switches 112, 122, 132, 142 to each of the other wireless switches 112, 122, 132, 142.

The wireless switches 112, 122, 132, 142 can also periodically send update messages to each other. If a certain amount of time passes and one of the wireless switches do not send update messages, then the other wireless switches can assume that wireless switch is no longer in the WLAN.

Typically, any communications between the registration sever 130 and the wireless switches 112, 122, 132, 142 over the IP sockets are unencrypted. However, in another embodiment, if security is a concern, the IP sockets (tunnels) can go over a security protocol, such as Internet Protocol Security (IPSec), and the communications can be encrypted using IPSec. “Internet Protocol Security (IPSec)” refers to a framework for a set of security protocols at the network or packet processing layer of network communication. IPsec can allow security arrangements to be handled without requiring changes to individual user computers. IPsec provides two choices of security service: Authentication Header (AH), which essentially allows authentication of the sender of data, and Encapsulating Security Payload (ESP), which supports both authentication of the sender and encryption of data as well. The specific information associated with each of these services is inserted into the packet in a header that follows the IP packet header. Separate key protocols can be selected, such as the ISAKMP/Oakley protocol. As will be described below, the client 202 can use IPSec terminated on the home wireless switch 212.

In another embodiment, it may be desirable to deploy redundant registration servers. When multiple registration servers 130 are implemented the configuration of the active or master registration server 130 can be synchronized with the configuration of a standby or slave registration server. That way, in the event the active or master registration server 130 fails, the standby or slave registration server can take over since it includes the same information (e.g., wireless switch list, active client list) as the active or master registration server 130.

In addition to the functionality related to the L3 roaming in WLANs, other functionality can be implemented in the registration server 130 that is typically implemented in other external servers. For example, the registration server 130 can host wireless intrusion detection system (WIDS) functionality, location server functionality, billing functionality, load balancing functionality, IP address assignment functionality, IP address management functionality, etc. Because the registration server 130 has information about each wireless switch (e.g., wireless switch list) and each client (e.g., active client list) in the WLAN, the registration server 130 can leverage this information with other functions provided by the additional functionality.

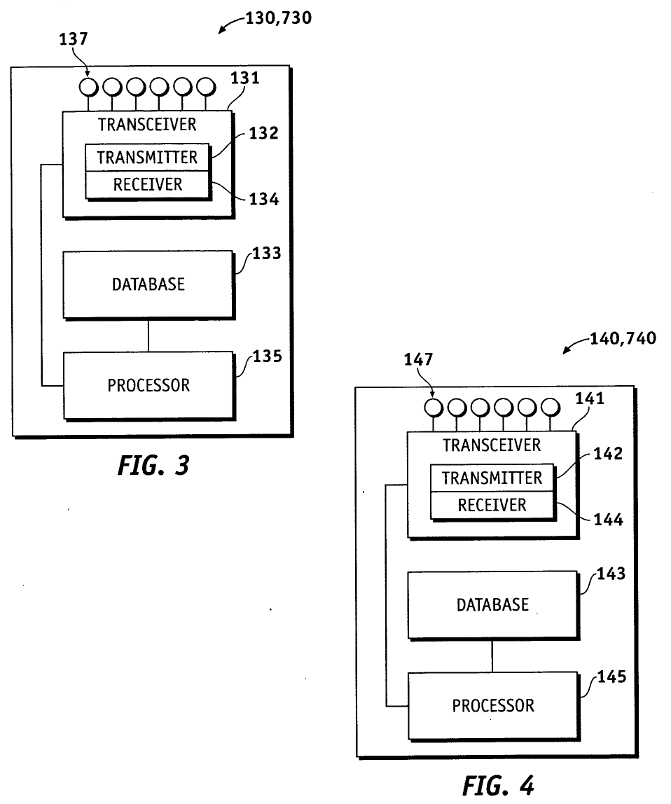

FIG. 3 is a block diagram of a registration server 130 according to one exemplary embodiment. The registration server 130 can include, for example, a transceiver 131 which includes a transmitter 132 and a receiver 134, a database 133, a processor 135 and a number of ports 137.

The receiver 134 of the registration server 130 can communicate the IP address of the registration server 130 to each of the wireless switches. Each of the wireless switches can use the IP address to open an IP socket to one of the ports. The receiver 134 receives configuration information from each wireless switch that includes attributes and parameters associated with each of the wireless switches 112, 122, 132, 142. This configuration information is communicated over a set of first IP sockets or tunnels between each of the wireless switches 112, 122, 132, 142 and the registration server 130. The configuration information for each wireless switch 112, 122, 132, 142 comprises a switch IP address and a list of subnets (IP domains) which the wireless switch supports. The processor 135 registers each of the wireless switches 112, 122, 132, 142 with the registration server 130 using the configuration information received from the wireless switches 112, 122, 132, 142 during registration and, optionally, updates received from the wireless switches 112, 122, 132, 142. The processor 135 can use the configuration information communicated received from the wireless switches 112, 122, 132, 142 to create an active wireless switch list (AWSL). The AWSL includes a listing of each of the wireless the switches in the WLAN. The transmitter 132 subsystem can communicate the configuration information for each of the wireless switches and the AWSL to each of the wireless switches. Each of the wireless switches can use the configuration information and the AWSL to open a UDP/IP socket to each of the other wireless switches. The database 135 can store the configuration information for each of the plurality of wireless switches and the AWSL.

FIG. 4 is a block diagram of a wireless switch 140 according to one exemplary embodiment. The wireless switch 140 could be implemented as any or all of the wireless switches 112, 122, 132, 142 described above. The wireless switch 140 can include, for example, a transceiver 141 which includes a transmitter 142 and a receiver 144, a database 143, a processor 145 and a number of ports 147.

The transmitter 142 can communicate configuration information about the wireless switch 140 to a registration server over an IP socket to the registration server 130. The transmitter 142 can also send configuration information for the wireless switch 140 to each of the other wireless switches.

The receiver 144 can receive configuration information for each of the other wireless switches and a copy of the AWSL which includes a listing of each of the other wireless switches in the WLAN.

The processor 145 can use the configuration information and the AWSL to open a UDP/IP sockets from the ports 147 to each of the other wireless switches.

The transmitter 142 can send the update messages for the wireless switch to each of the other wireless switches. The receiver 144 can also receive update messages from each of the other wireless switches. These update messages comprise changes to configuration information for each of the other wireless switches.

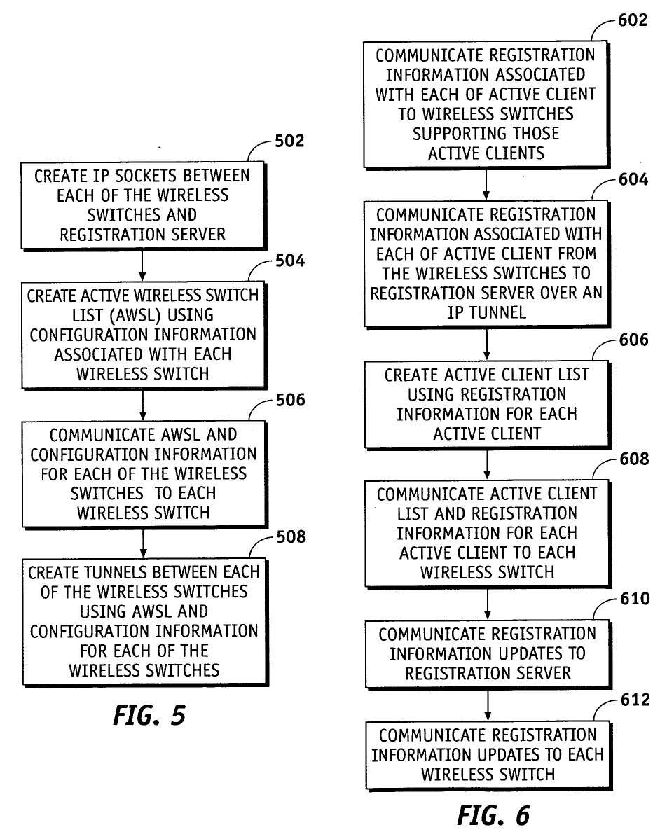

FIG. 5 is a flow chart showing an exemplary method creating a mesh network of wireless switches in a WLAN comprising a wireless switches 112, 122, 132, 142 and a registration server 130. An IP address of the registration server 130 can be configured on each of the wireless switches 112, 122, 132, 142.

At step 502, the IP address of the registration server 130 can be used to create or open an IP socket from each of the wireless switches 112, 122, 132, 142 to the registration server 130. Each of the wireless switches 112, 122, 132, 142 can register with the registration server 130 by communicating configuration information about each of the wireless switches 112, 122, 132, 142 to the registration server 130. In one implementation, the configuration information for each switch 112, 122, 132, 142 comprises a switch IP address and a list of subnets the switch supports.

At step 504, the registration server 130 can use the configuration information to create an active wireless switch list (AWSL) which includes a listing of each of the wireless switches 112, 122, 132, 142 in the WLAN.

At step 506, the AWSL and the configuration information for each of the wireless switches 112, 122, 132, 142 can then be communicated to each of the wireless switches 112, 122, 132, 142.

At step 508, each of the wireless switches 112, 122, 132, 142 can use the configuration information and the AWSL to open a UDP/IP socket to each of the other wireless switches 112, 122, 132, 142. Each wireless switch is then connected to each of the other wireless switches 112, 122, 132, 142 and a mesh network of wireless switches 112, 122, 132, 142 is created.

In other implementations, each of the wireless switches 112, 122, 132, 142 can send configuration information to each of the other wireless switches 112, 122, 132, 142. Alternatively, the registration server 130 can send the configuration information and the AWSL for each of the wireless switches 112, 122, 132, 142 to each of the other wireless switches 112, 122, 132, 142. Each wireless switch 112, 122, 132, 142 can also send update messages to each of the other wireless switches 112, 122, 132, 142. These update messages can include, for example, changes to configuration information for each wireless switch 112, 122, 132, 142.

FIG. 6 is a flow chart showing an exemplary method for providing an active client list (ACL) to a plurality of wireless switches 112, 122, 132, 142 according to one exemplary embodiment. The wireless switches 112, 122, 132, 142 can be located, for instance, in a WLAN such as the WLAN of FIG. 2 comprising a registration server 130 and a plurality of active clients (not shown) supported by the wireless switches 112, 122, 132, 142.

At step 602, registration information associated with each of the active clients is communicated to the wireless switches 112, 122, 132, 142 that support those active clients. At step 604, the registration information associated with each of the active clients is communicated from the wireless switches 112, 122, 132, 142, over an IP tunnel, to the registration server 130. At step 606, an active client list can be created using the registration information for each active client. The active client list comprises a record for each active client in the WLAN. The record of each client comprises a MAC address of the client, a client IP address of the client, a home switch of the client, a visited switch of the client, inactivity timers for the home switch and the visited switch and location information. At step 608, the active client list and the registration information for each active client is communicated to each wireless switch 112, 122, 132, 142. At step 610, registration information updates are communicated from each wireless switch 112, 122, 132, 142 to the registration server 130. The registration server 130 can use the registration information updates received from the wireless switches 112, 122, 132, 142 to update the active client list. At step 612, the registration information updates are communicated to each of the other wireless switches 112, 122, 132, 142 in the WLAN. Alternatively, the registration server 130 can communicate an updated active client list including the registration information updates to the active client list to each wireless switch 112, 122, 132, 142.

Referring again to FIG. 3, the registration server 130 can include ports 137, a transceiver 131 comprising a transmitter 132 and a receiver 134, a processor 135, a database 133. Selected ports couple the registration server 130 to the wireless switches 112, 122, 132, 142 via IP sockets. The receiver 134 can receive registration information for each active client from the wireless switch that supports each active client. The processor 135 can create an ACL using the registration information for each active client. The database 135 can store the ACL and registration information for each active client, and the transmitter 132 can communicate the ACL and registration information for each active client to each wireless switch. In one implementation, the wireless switches send registration information updates. The receiver 134 can receive registration information updates from the wireless switches, and the processor 135 can use the registration information updates to create an updated ACL. The transmitter 132 can then send the registration information updates to each of the wireless switches. In another implementation, the wireless switches send registration information updates to the receiver 134, and the processor 135 can use the registration information updates to update the ACL. The transmitter 132 can send the registration information updates to the ACL to each wireless switch 112, 122, 132, 142 as the registration information updates are received from the wireless switches 112, 122, 132, 142.

Referring again to FIG. 4, each of the wireless switches 112, 122, 132, 142 can include, for example, a number of ports 147, a transceiver 141 including a transmitter 142 and a receiver 144, a processor 145 and a database 143. The receiver 144 can receive registration information from each of the active clients the wireless switch supports. The ports 247 couple the wireless switches 112, 122, 132, 142 to the registration server 130 via IP sockets. The transmitter 142 transmits the registration information to the registration server 130. The receiver 144 can receive the ACL from the registration server 130. The ACL comprises a record for each of the active clients in the WLAN. The receiver 144 can also receive registration information updates from each of the active clients the wireless switch supports, and the transmitter 142 can send the registration information updates to the registration server 130. The transmitter 142 can also send the registration information updates to each of the other wireless switches in the WLAN. The receiver 144 can receive an updated ACL from the registration server 130 which includes the registration information updates received from each of the wireless switches.

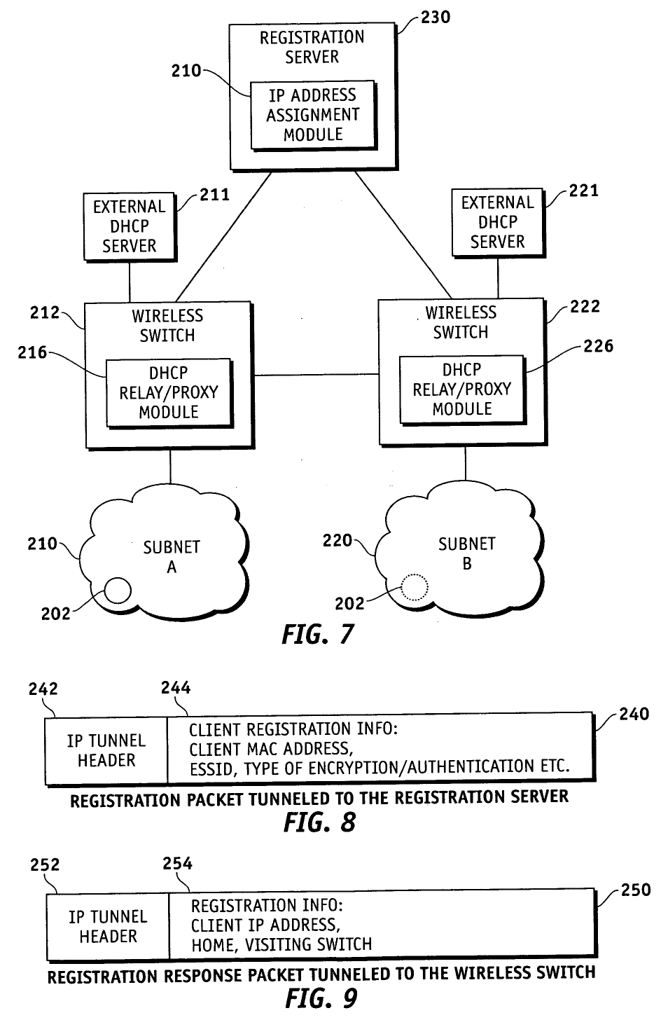

As shown in FIG. 13, for each wireless switch 712, 722, 732, 742 in the WLAN, a separate external DHCP server 711, 721, 731, 741 with an Ethernet interface can be provided. In this architecture, each DHCP server 711, 721, 731, 741 supports a single IP subnet associated with a particular wireless switch. A particular external DHCP server 711, 721, 731, 741 receives all DHCP requests for IP addresses which are broadcast from all clients on a given subnet, and assigns IP addresses to all clients of that given subnet. For example, the wireless switch 712 has DHCP relay functionality in response to a DHCP request from a specific wireless client. In other words, the wireless switch 712 forwards the DHCP request from a specific wireless client to an appropriate external DHCP server 711 based on the registration information. According to other embodiments described below with reference to FIGS. 7-12, the registration server 230 can perform IP address assignment and management functions which are typically performed at the DHCP server.

IP Address Assignment Module Hosted at the Registration Server

FIG. 7 is a block diagram of a WLAN according to one exemplary embodiment. The WLAN comprises a registration server 230, external DHCP servers 211, 221 and a plurality of wireless switches 212, 222 each of which support a subnet 210, 220. Although FIG. 7 shows two wireless switches 212, 222 any number of wireless switches could be supported by the registration server 230.

Each of the wireless switches communicates with the registration server 230 over an IP tunnel as discussed above. Each of the wireless switches 212, 222 supports a subnet 210, 220 and has a number of access ports (not shown) within a given subnet. Each of the access ports is capable of supporting a plurality of wireless clients (not shown). Each of the wireless switches 212, 222 comprises a DHCP Relay/Proxy module 216, 226 which runs on each wireless switch 212, 222. The DHCP relay module will relay DHCP request from the wireless client to the home wireless switch or to the local DHCP server. The DHCP proxy module will respond to the DHCP request if the wireless switch has already both registration info and the IP address of the wireless client. The DHCP Relay/Proxy module 216, 226 will be described in greater detail below.

The registration server 230 comprises an IP address assignment module 232 which can provide centralized management of IP addresses, and centralized IP address assignment for all wireless clients in the WLAN. This IP address assignment module 232 is hosted and runs at the registration server 230. Among other functions, this IP address assignment module 232 can be responsible for assigning IP addresses for all wireless clients in the WLAN.

This IP address assignment module 232 handles a pool of IP addresses for each IP subnet 210, 220 used in the network. In one embodiment, the IP address assignment module 232 can be configured to assign IP addresses for all mobile, wireless clients from different pools of IP addresses for each subnet 210, 220. Based on the subnet topology of the WLAN, a different sub-pool of IP addresses can be assigned for each subnet. For example, in the embodiment shown in FIG. 7, a first sub-pool of IP addresses is associated with a first subnet 210, a second sub-pool of IP addresses is associated with a second subnet 220, and so on. In one exemplary implementation, the IP address assignment module 232 can keep a table which associates an IP address of a first wireless switch 210 with the first sub-pool, associates an IP address of a second wireless switch 222 with the second sub-pool, etc. This can help ensure that an IP address assigned to a particular client is associated with the appropriate subnet for that particular client. The IP address assignment module 232 can be configured such that it assigns IP addresses from pool of IP addresses not overlapping with other pools of IP addresses used by external DHCP servers 211, 221 which are locally connected to the wireless switches 212, 222. The pools of IP addresses assigned to the external DHCP servers 211, 221 can be used for wired clients.

The IP address assignment module 232 can be implemented as either software module running on a processor in the registration server 230 or a separate dedicated computer which implements the functionality of the IP address assignment module 232. In one embodiment, client registration, discussed above, and IP address assignment can be done at the same time at the registration server 230. Moreover, IP address assignment can take place concurrently with registration of each wireless client. Centralizing IP address assignment and management at the registration server 230 for all wireless clients tends to greatly simplify wireless network deployment and client registration process. It also reduces roaming time which can be very critical in some applications like VoIP.

When a wireless client 202 discovers a new subnet 220, either by powering up on a new subnet or roaming to a new subnet, the wireless client 202 will undergo 802.11 authentication and association procedures as well as 802.1x authentication procedure. Once a wireless client 202 gets 802.11 authenticated and associated as well as 802.1x authenticated it will send DHCP request to the wireless switch 222. The wireless switch 222 will proxy this DHCP request. The wireless switch 222 will tunnel the DHCP request to the registration server 230 through existing IP tunnel or socket which was created during wireless switch registration process.

FIG. 8 is a block diagram of an exemplary registration packet 240 generated by the wireless switch 222 and tunneled to the registration server 230 by the wireless switch 222 according to one embodiment. This registration packet 240 comprises an IP tunnel header 242 and client registration information 244 about the wireless client. The client registration information 244 is collected during 802.11 authentication/association and 802.1x authentication. In this embodiment, the client registration information 244 includes the client's MAC address, the ESSID, the type of encryption being used, the type of authentication being used, and channel number. The wireless switch uses the IP tunnel header 242 to route the registration packet 240 to the registration server 230 through an IP tunnel or “socket” which was created during wireless switch registration process.

The registration server 230 adds the client registration information 244 into an Active Client List (ACL) which is described above.

After analyzing the client registration information, the registration server 230 can assign, for example, home and visited wireless switches to the client 202 based on the client registration information 244. The home and visited wireless switch can be assigned as discussed below with respect to FIGS. 14-20. It should be appreciated that the wireless switch which sent the registration request does not have to become the home wireless switch. The home and visited wireless switch can then be added to the client's record in the ACL.

The IP address assignment module 232 looks into the IP address of the home wireless switch and determines whether the home wireless switch has a record for the wireless client 202. If the home wireless switch does have a record for the wireless client, then the home wireless switch simply reassigns the existing IP address for the client to the client. If the home wireless switch does not have a record for the wireless client, then the IP address assignment module 232 assigns a particular IP address to the wireless client from the pool of IP addresses assigned to the subnet supported by the home wireless switch. This particular IP address will be added to the wireless client record in the ACL.

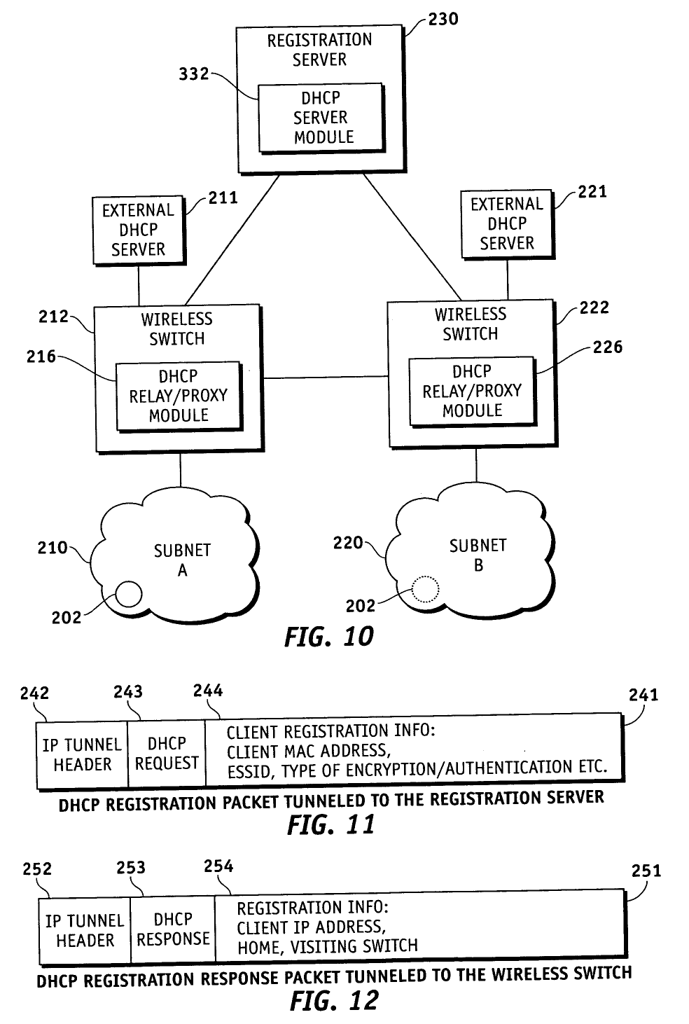

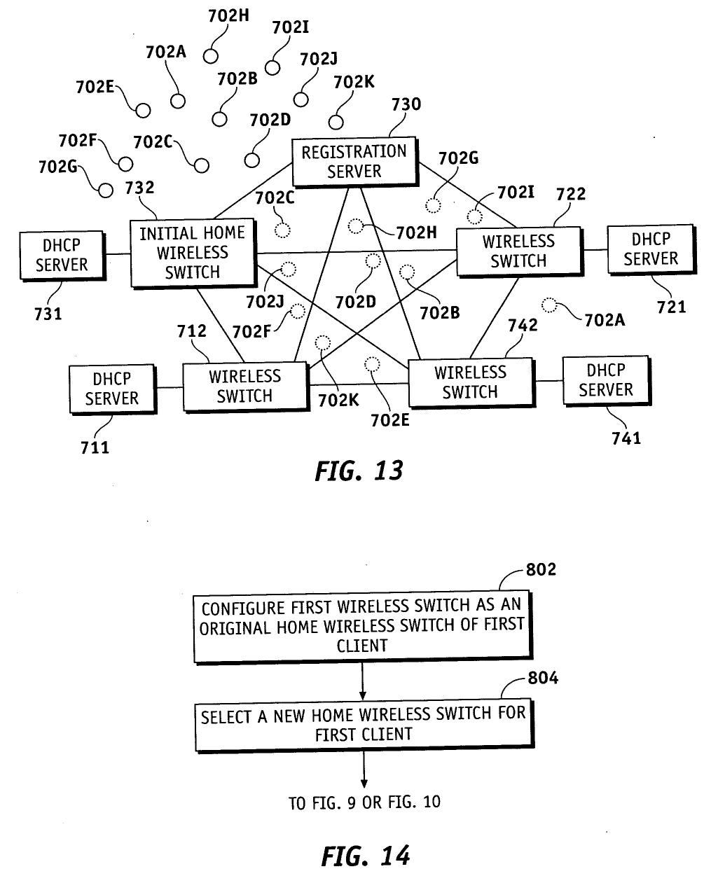

FIG. 9 is a block diagram of an exemplary registration response packet 250 generated by the registration server 230 and tunneled to the home wireless switch 222 by the registration server 230 according to one embodiment. The registration server 230 generates the registration response packet 250 and tunnels it back to the wireless switch which initially communicated the registration packet 240 to the registration server 230. This registration response packet 250 comprises an IP tunnel header 252 and registration information 254 about the wireless client. The registration information 254 is assigned to a particular client by the registration server 230. In this embodiment, the registration information 254 includes the client IP address, the home wireless switch for the client and the visited wireless switch of the client plus the client's MAC address, the ESSID, the type of encryption being used, the type of authentication being used, channel number. The registration server 230 uses the IP tunnel header 252 to send the registration response packet 250 through the IP tunnel or “socket” to the wireless switch which initially communicated the registration packet 240 to the registration server 230. This wireless switch can then forward the DHCP response from the registration information 254 to the wireless client and save the registration information 254 in the appropriate wireless client record of the Active Station List. The registration server 230 can also forward the registration information 254 plus registration 244 including the client's MAC address, the ESSID, the type of encryption being used, the type of authentication being used, and channel number to all other wireless switches in the WLAN.

Dedicated DHCP Server Module Hosted at Registration Server

FIG. 10 is a block diagram of a WLAN according to another exemplary embodiment. The WLAN of FIG. 10 is similar to that shown in FIG. 7 in that it comprises a registration server 230, external DHCP servers 211, 221 and a plurality of wireless switches 212, 222 each of which support a subnet 210, 220. Although FIG. 10 shows two wireless switches 212, 222 any number of wireless switches could be supported by the registration server 230.

In this implementation, the IP address assignment module 232 comprises a dedicated DHCP server module 332 running at the registration server 230. The dedicated DHCP server module 332 is in charge of assigning IP addresses for all wireless clients in the WLAN. The dedicated DHCP server module 332 is hosted on the registration server 230. The DHCP server module 332 is in charge of assigning IP addresses for all wireless clients in the WLAN, and can be configured to handle a pool of IP addresses for each IP subnet used in the network. The DHCP server module 332 assigns IP addresses from the pools of IP addresses not overlapping with pools used by local DHCP servers 211, 221 connected to the wireless switches 212, 222.

When a wireless client 202 discovers a new subnet 220, either by powering up on a new subnet or roaming to a new subnet, the wireless client 202 will undergo 802.11 authentication and association procedures as well as 802.1x authentication procedure. Once a wireless client gets 802.11 authenticated and associated as well as 802.1x authenticated it will send DHCP request to the wireless switch. The wireless switch will proxy this DHCP request. As discussed above, each wireless switch 212, 222 comprises a DHCP Relay/Proxy module 216, 226 running on the wireless switch. The DHCP Relay/Proxy module 216, 226 provides relay and proxy functionality.

When a client 202 roams from a first wireless switch 210 to a second wireless switch 220, the client 202 sends a DHCP request to the second wireless switch 220. It should be appreciated that each wireless switch can communicate DHCP requests from specific wireless clients to the registration server 230. Each DHCP request includes the MAC address of the client. The wireless switch 222 will tunnel the DHCP request 243 to the registration server 230 through existing IP tunnel or socket which was created during wireless switch registration process. The second wireless switch 222 can include a DHCP proxy module configured to proxy the DHCP request sent from the client to the second wireless switch, use the DHCP request to determine the MAC address of the client, and determine if the second wireless switch 222 already has a record (distributed by the registration server during registration) for the client 202 based on the MAC address of that client 202. This record includes authentication and association information associated with the client.

If the DHCP server module 332 determines that the second wireless switch 222 already has a record (distributed by the registration server during registration) for the client 202, then the DHCP server module 332 simply re-assigns the existing IP address for the client 202 to that client 202. If the DHCP server module 332 determines that the second wireless switch 222 already has a record (distributed by the registration server during registration) for the client 202, then the DHCP server module 332 will assign a new IP address to the client 202.

FIG. 11 is a block diagram of an exemplary DHCP registration packet 241 generated by the wireless switch 222 and tunneled to the registration server 230 by the wireless switch 222 according to one implementation. This registration packet 241 generated by the wireless switch 222 comprises an IP tunnel header 242, a DHCP request 243, and client registration information 244 about the wireless client. The client registration information 244 is collected during 802.11 authentication/association and 802.1x authentication. In this embodiment, the client registration information 244 includes the client MAC address, the ESSID, the type of encryption being used, the type of authentication being used, and channel number.

The wireless switch uses the IP tunnel header 242 to send or tunnel the registration packet 241 to the registration server 230through an IP tunnel or “socket” which was created during wireless switch registration process. The DHCP request will be processed by the dedicated DHCP server module 332 running on the registration server 230. The registration server 230 adds the client registration information 244 into an Active Client List (ACL).

The registration server 230 can assign, for example, home and visited wireless switches to the client based on the client registration information 244. The home and visited wireless switch can be assigned as discussed below with respect to FIGS. 14-20. It should be appreciated that the wireless switch which sent the registration request does not have to become the home wireless switch. The home and visited wireless switch can then be added to the client's record in the ACL. The IP address of the assigned home wireless switch will be forwarded to the dedicated DHCP server module 332.

The dedicated DHCP server module 332 looks into the IP address of the home wireless switch and assigns a particular IP address to the wireless client from the pool of IP addresses assigned to the subnet supported by the home wireless switch. This particular IP address will be added to the wireless client record in the ACL.

FIG. 12 is a block diagram of an exemplary DHCP registration response packet 251 generated by the registration server 230 and tunneled to the wireless switch 222 by the registration server 230 according to one implementation.

The registration server 230 generates the DHCP registration response packet 251 and tunnels it back to the wireless switch which initially communicated the registration packet 241 to the registration server 230. This DHCP registration response packet 251 comprises an IP tunnel header 252, a DHCP response 253 and registration information 254 about the wireless client. The registration information 254 is assigned to a particular client by the registration server 230. In this embodiment, the registration information 254 includes the client IP address, the home wireless switch for the client and the visited wireless switch of the client, plus registration info 244 including the client's MAC address, the ESSID, the type of encryption being used, the type of authentication being used, and channel number. The registration server 230 uses the IP tunnel header 252 to send the registration response packet 251 through the IP tunnel or “socket” to the wireless switch which initially communicated the registration packet 240 to the registration server 230. This wireless switch can then forward the DHCP response to the wireless client and save the registration information 254 in the appropriate wireless client record of the Active Station List. The DHCP response 253 can then be forwarded to the wireless client 202. This way, to the client, a DHCP response appears to come from an external DHCP server 211, 221 associated with a particular wireless switch 212, 222, when in reality all DHCP responses are sent from the IP address assignment module 232. The registration server 230 can also forward the registration information 254 to all other wireless switches in the WLAN.

IP Address Assignment During Roaming and DHCP Proxy Functionality

As noted above, a DHCP Relay/Proxy module 216, 226 runs on each wireless switch 212, 222. The DHCP proxy functionality of the DHCP Relay/Proxy module 226 will now be described in detail.

When a wireless client 202 roams from a wireless switch 212 to the wireless switch 222, and after 802.11 authentication, association and 802.1x authentication of the wireless client, the wireless client sends a DHCP request to the wireless switch 222. The wireless switch 222 will proxy this DHCP request from the wireless client, and use the DHCP request to determine the MAC address of that specific client. From the MAC address of that specific client, the wireless switch 222 can determine if the wireless switch 222 already has a record for the specific client. In other words, the record for this wireless client 202 has already been distributed by the registration server 230 to the wireless switch 222.

If the wireless switch 222 does not have the record for this wireless client, then the wireless switch 222 communicates with the registration server 230 and attempts to register the specific client 202 with the registration server 230. The wireless switch 222 encapsulates or repackages the DHCP request 243 from the specific client and sends it to the registration server 230 as a registration packet 240, 241. The registration server 230 sends a DHCP response 253 to the wireless switch 222 over an IP tunnel between the wireless switch 222 and the registration server 230. The DHCP response 253 can be part of a packet, such as the registration response packet 250, 251. The wireless switch 222 can use this DHCP response to determine the IP address of the specific client.

By contrast, if the wireless switch 222 has a record for this specific wireless client 202 (obtained during the registration process), the record includes authentication and association information associated with the specific wireless client 202. The wireless switch 222 can reassign the same IP address to this wireless client 202 and send a DHCP response 253 back to the wireless client 202 over a tunnel between the particular wireless switch 222 and the client 202. This DHCP response 253 re-assigns the wireless client 202 the same IP address and thereby allows the wireless client 202 to maintain the same IP address. This DHCP proxy functionality eliminates the need for the registration server 230 to tunnel DHCP requests to the external DHCP server 221. This will reduce the time needed to get the same IP address re-assigned, since the wireless switch 222 does not have to send a DHCP request out to the external DHCP server 221 and wait for a DHCP response 253 from that external DHCP server 221. This can reduce roaming time. With respect to wired clients, the wired clients can still communicate with the external DHCP servers 211, 221 connected to the particular wireless switch 212, 222. External DCHP servers 211, 221 locally connected to the wireless switches 212, 222 can be used to assign IP addresses to wired clients only.

Referring again to FIG. 3, the registration server 130 can include ports 137, a transceiver 131 comprising a transmitter 132 and a receiver 134, a processor 135, a database 133. Selected ports couple the registration server 130 to the wireless switches 112, 122, 132, 142 via IP sockets. The processor 135 can use information from the wireless switches to generate a pool of IP addresses which comprises a plurality of sub-pools of IP addresses with each sub-pool including IP addresses supported by one of the subnets in the WLAN. The processor 135 receives, from one of the wireless switches, a registration packet comprising an IP tunnel header, wireless client registration information, and optionally a Dynamic Host Configuration Protocol (DHCP) request for an Internet Protocol (IP) address which originates from one of the wireless clients associated with the subnet of that wireless switch. The DHCP request can be encapsulated in the registration packet. The processor 135 can implement the functionality of the “IP address assignment module,” and is responsible for assigning IP addresses to the wireless clients of the wireless network. For example, the processor 135 can assign an IP address to a given wireless client from the sub-pool associated with the particular subnet the given wireless client is associated with. As such, the IP address assigned to the given wireless client is associated with the particular subnet for that given wireless client. The processor 135 can also manage the pool of IP addresses for all of the wireless clients in the wireless network.

The database 133 can store the Active Wireless client List (ACL). The processor 135 can add the wireless client registration information into the Active Wireless client List (ACL). The wireless client registration information comprises, among other things, the wireless client's Media Access Control (MAC) address and an Extended Service Set Identifier (ESSID). The processor 135 assigns home and visited wireless switches to the wireless client based on the wireless client registration information. The processor 135 can also include DHCP relay functionality which can be used to generate a registration response packet in response to the DHCP request. This registration response packet which comprises an IP tunnel header, registration information about the wireless client, and optionally a DHCP response encapsulated within the DHCP registration response packet by the IP tunnel header and the registration information. The registration information comprises an IP address assigned to the wireless client, a home wireless switch assigned to the wireless client and a visited wireless switch assigned to the wireless client.

The transmitter 132 can communicate or tunnel the registration response packet to wireless switch which initially communicated the registration packet to the registration server.

Referring again to FIG. 4, each of the wireless switches 112, 122, 132, 142 can include, for example, a number of ports 147, a transceiver 141 including a transmitter 142 and a receiver 144, a processor 145 and a database 143. Each of the wireless switches 112, 122, 132, 142 can be configured to support a particular subnet and can use the transceiver 141 to communicate with the registration server over one of the IP tunnels. The ports 147 couple the wireless switches 112, 122, 132, 142 to the registration server 130 via IP sockets.

The receiver 144 can receive a Dynamic Host Configuration Protocol (DHCP) request for an Internet Protocol (IP) address from a wireless client associated with one of the subnets, such as, the first subnet. The processor 145 can be used to implement the functionality of a DHCP proxy module. The processor 145 can use the DHCP request to determine the MAC address of the wireless client, and can determine if the database 143 already has a record for the wireless client based on the MAC address of that wireless client. The record for the wireless client includes authentication and association information associated with the wireless client. If the database 143 has a record for the wireless client, then the transmitter 142 returns a DHCP response to the wireless client which assigns the existing IP address of the wireless client to the wireless client.

However, if the database 143 does not have a record for the wireless client, then the processor 145 generates a registration packet and the transmitter 142 sends the registration packet to the registration server 130 over one of the IP tunnels. The registration packet comprises an IP tunnel header for sending the registration packet to the registration server, wireless client registration information associated with the wireless client, and optionally a DHCP request from the wireless client encapsulated in the registration packet. The wireless client registration information comprises, among other things, the wireless client Media Access Control (MAC) address, an Extended Service Set Identifier (ESSID), the type of encryption being used, and the type of authentication being used. Once the transmitter 142 transmits the registration packet to the registration server 130, the registration server 130 can use the DHCP request to generate a registration response packet.

In response to the DHCP request, the receiver 144 can receive a registration response packet from the registration server 130, which can include an IP tunnel header, an optional DHCP response, and registration information about the wireless client. When implemented, the DHCP response can be encapsulated within the registration response packet by the IP tunnel header and the registration information about the wireless client. The registration information comprises an IP address assigned to the wireless client, a home wireless switch assigned to the wireless client, and a visited wireless switch assigned to the wireless client. The processor 145 can determine the IP address of the wireless client based on the DHCP response.

The transmitter 142 can also send the registration information to the wireless client and also each of the other wireless switches in the WLAN.

L3 Mobility and WLAN Load Balancing

In one embodiment, the registration server 230 or the switches can monitor the inactivity timers. If the inactivity timers of the client 202 indicate that the client 202 is inactive on its home switch (and the visited switch) for a given period of time, then the registration server 230 forces the client 202 to 802.11 reauthenticate and reassociate and get a new client IP address on a new wireless switch. This allows the WLAN to avoid transmitting unnecessary overhead and cleans up unnecessary traffic in the tunnels between switches.

FIG. 13 is a block diagram of a WLAN according to one exemplary embodiment which implements a registration server 730 and a plurality of wireless switches 712, 722, 732, 742 including an original home wireless switch 732 of a client 702A. Each of the wireless switches 712, 722, 732, 742 has a DHCP server 711, 721, 731, 741 associated with it. In conjunction with this embodiment, techniques for WLAN load balancing will now be described.

To illustrate the techniques for WLAN load balancing, the following example assumes that wireless switch 732 is a client's original home wireless switch and is relatively overloaded with clients with respect to at least one of the other wireless switches 712, 722, 742. After a given client 702A gets 802.11 authenticated/associated, and 802.1x authenticated on the original home wireless switch 732, the client 702A will send a DHCP request to the original home wireless switch 732. If the original home wireless switch 732 becomes overloaded with other clients, it may no longer be practical for the original home wireless switch 732 to remain the home wireless switch for this client 702A. To address this problem, the original home wireless switch 732 can forward a DHCP request to another wireless switch 712, 722, 742 in the network which is likely or definitely determined to be less loaded with client's 702A-702K than the original home wireless switch 732. Before forwarding the DHCP request to another wireless switch in the WLAN, the original home wireless switch 732 should determine which wireless switch 712, 722, 732, 742 in the WLAN is the best candidate to become the new home wireless switch for the client 702A. The original home wireless switch 732 can select either itself or any of the other wireless switches 712, 722, 742 to forward the DHCP request to. This selection can be accomplished by a number of different methods. In the description of FIGS. 7-11 which follows, the original home wireless switch 732 is assumed to be overloaded with clients 702A-702K or client traffic with respect to the other wireless switches 712, 722, 742 such that at least one of the other wireless switches is currently handling less traffic that the original home wireless switch 732. Therefore the original home wireless switch 732 will select one of the other wireless switches 712, 722, 742 as a new home wireless switch and forward the DHCP request to the other wireless switch 712, 722, 742 which is selected. Nevertheless, in a given situation, it should be appreciated that the original home wireless switch 732 could select itself as a new home wireless switch if it determines that it is currently the least loaded wireless switch in the WLAN.

In this embodiment, the original home wireless switch 732 can determine which of the other wireless switches 712, 722, 742 in the WLAN is the best candidate to become the new home wireless switch for the client 702A by selecting the wireless switch handling the least amount of traffic based on attributes in a traffic load records (TLRs) associated with each of the wireless switches 712, 722, 742 in the WLAN. This mechanism for selecting a new home wireless switch from a number of candidate wireless switches 712, 722, 742 can run continuously or it can be triggered when the original home wireless switch 732 exceeds predefined traffic load threshold (TLT).

Each of the wireless switches 712, 722, 732, 742 can periodically report a traffic load record (TLR) to the registration server 730. For a given wireless switch, the TLR can contain, for example, information concerning the number of clients a given switch supports as a home switch, the number of clients the given switch supports as a visited switch, the amount of traffic (Mb/s) being tunneled to the given switch (since it is home switch for some clients), the amount of traffic (Mb/s) tunneled from the given switch (since it is visiting switch for some clients), and the amount of traffic (Mb/s) being transferred by the given switch.

The registration server 730 can use the TLRs from each of the wireless switches 712, 722, 732, 742 to generate a network load report (NLR) which includes information about traffic load of each of the wireless switches 712, 722, 732, 742 in the WLAN. The registration server 730 can periodically distribute the NLR to each of the wireless switches 712, 722, 732, 742 in the WLAN. In one embodiment, the NLR may comprise a system traffic load table (STLT) which includes information from the TLRs of each of the wireless switches 712, 722, 732, 742 in the WLAN.

The original home wireless switch 732 can use the NLR, and attributes from the TLRs for each of the other wireless switches, to determine which of the other wireless switches 712, 722, 742 in the WLAN is currently handling the least amount of traffic, and select that switch as the best candidate to become the new home wireless switch for the client 702A. Once the original home wireless switch 732 selects one of the other wireless switches 712, 722, 742, such as wireless switch 722, as the new home wireless switch for the client 702A, then the original home wireless switch 732 can also redirect any DHCP requests received from a new client or clients (not known by the network; with no home switch being assigned) to new home wireless switch.

The original home wireless switch 132 can randomly determine which of the other wireless switches 712, 722, 742 in the WLAN will become the new home wireless switch for the client 702A. For example, the original home wireless switch 732 can hash the client's MAC address and optionally some other data from a DHCP request packet to determine a hash value. The hash value can have a range of values. For example, in the WLAN implementation of FIG. 13 where four wireless switches are used, the hash value (x) can be between 0 and 256. The hash value (x) may be determined by the following equation:
x=MAC[0] XOR MAC[1] XOR MAC[3] XOR MAC[4] XOR MAC[5] XOR MAC[6]

Once the hash value (x) is determined, then the original home wireless switch 732 can use it to determine which of the wireless switches 712, 722, 732 742 should be assigned as the client's new home wireless switch. For example, in one possible implementation, if the hash value (x) is less than 64, then the wireless switch 712 can become the new home wireless switch; if the hash value (x) is greater than or equal to 64 and less than 128, then wireless switch 722 will become the new home wireless switch; if the hash value (x) is greater than or equal to 128 and less than 192, then wireless switch 732 will remain as the new home wireless switch; and if the hash value (x) is greater than or equal to 192 and less than 255, then wireless switch 742 will become the new home wireless switch.

Thus, according to this implementation, the home switch is assigned by the hashing algorithm and the traffic load is randomly balanced. Depending on the hash value (x) that is determined, it is possible that the original home wireless switch 732 will be selected or remain as the client's new home wireless switch. However, the new home wireless switch assigned by hashing algorithm can already be overloaded. In another implementation, when the original home wireless switch 732 is known to be overloaded, the original home wireless switch can select one of the other wireless switches 712, 722, 742.

If the original home wireless switch 732 decides, for instance, that wireless switch 122 is the best candidate to become the new home wireless switch, and then the original home wireless switch 732 can forward a DHCP request to wireless switch 722. A DHCP server (not shown) which is connected to the wireless switch 722 can then assign an IP address to the client 702A and become the client's new home wireless switch. New home wireless switch 722 will tunnel a DHCP response to the original home wireless switch 732. The original home wireless switch 732 then becomes this client's visited wireless switch and wireless switch 722 becomes client's new home wireless switch. All traffic coming from this client 702A will be tunneled to the new home wireless switch 722. Once the client 702A roams to another switch in the WLAN such as wireless switch 712, wireless switch 712 will become the new visited wireless switch and wireless switch 722 will remain as the home switch. All traffic for this client 702A is tunneled to new home wireless switch 722 by the new visited wireless switch 712. At this point, original home wireless switch 732 which first accepted the connection from this client 702A no longer handles this client's traffic.

FIG. 14 is a flow chart showing an exemplary method for load balancing in wireless local area network comprising a plurality of wireless switches 712, 722, 732, 742 configured to support a plurality of client's 702A-702K including a first client 702A according to one exemplary embodiment. Each of the wireless switches 712, 722, 732, 742 can be coupled to each of the other wireless switches 712, 722, 732, 742 via a UDP/IP socket.

At step 802, an original home wireless switch is configured as an initial home wireless switch of the first client. At step 804, the original home wireless switch can select one of a plurality of wireless switches 712, 722, 732, 742 as a new home wireless switch for the first client. Again, the original home wireless switch 732 is assumed to be overloaded with clients 702A-702K or client traffic with respect to the other wireless switches 712, 722, 732, 742 712, 722, 742 such that at least one of the other wireless switches 712, 722, 732, 742 is currently handling less traffic that the original home wireless switch 732. Nevertheless, in a given situation, it should be appreciated that the original home wireless switch 732 could select itself to remain as the home wireless switch if it determines that it is currently the least loaded wireless switch in the WLAN.

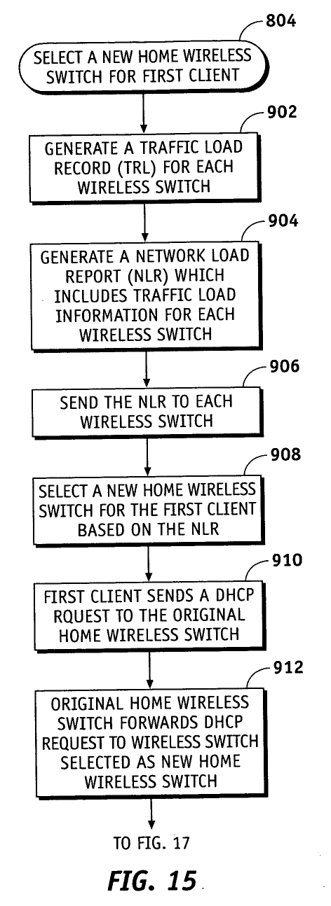

FIG. 15 is a flow chart showing a method for a home wireless switch 732 to select one of a plurality of wireless switches 712, 722, 732, 742 in a WLAN as a new home wireless switch for the first client 702A according to one exemplary embodiment. Each wireless switch 712, 722, 732, 742 can be configured to monitor traffic being tunneled to and from the wireless switch.

At step 902, each of the wireless switches 712, 722, 732, 742 generates a traffic load record (TLR). The traffic load record (TLR) for each wireless switch7l2, 722, 732, 742 can include a parameter which specifies the number of clients 702A-702K the switch 712, 722, 732, 742 supports as a home switch, a parameter which specifies the number of clients 702A-702K the switch 712, 722, 732, 742 supports as a visited switch, a parameter which specifies traffic volume being tunneled to the switch 712, 722, 732, 742, a parameter which specifies traffic volume being tunneled from the switch 712, 722, 732, 742, and a parameter which specifies traffic volume being transferred by the switch 712, 722, 732, 742.

At step 904, the registration server 730 can generate a network load report (NLR) which includes traffic load information for each of the wireless switches 712, 722, 732, 742. At step 906, the registration server 730 can send the NLR to each of the wireless switches 712, 722, 732, 742. At step 908, the home wireless switch 732 can select one of the wireless switches 712, 722, 732, 742 as a new home wireless switch for the first client 702A based on the NLR and the TLRs for each wireless switch 712, 722, 732, 742. For example, in one embodiment, the original home wireless switch 732 can select one of the wireless switches 712, 722, 732, 742 as a new home wireless switch for the first client 702A by using the NLR to determine which of the wireless switches 712, 722, 732, 742 is currently handling the least amount of traffic, and selecting the wireless switch 712, 722, 732, 742 which is currently handling the least amount of traffic as the new home wireless switch for the first client 702A. In one exemplary implementation, the home wireless switch can use attributes in traffic load records (TLRs) associated with each of the wireless switches 712, 722, 732, 742 to select the wireless switch, which is handling the least amount of traffic, as the new home wireless switch for the first client 702A.

At step 910, the first client 702A sends a DHCP request to the home wireless switch. At step 912, the home wireless switch can forward the DHCP request to the wireless switch selected as the new home wireless switch. Although not shown in FIG. 15, when a new client 702A joins the WLAN, the home wireless switch can redirect a DHCP request received from the new client 702A and send the DHCP request to the wireless switch selected as the new home wireless switch.

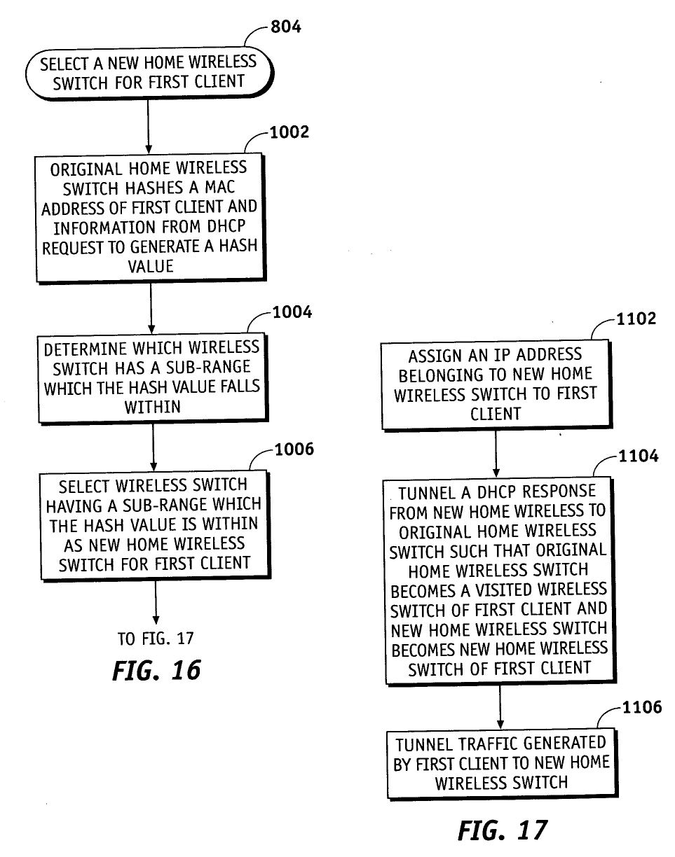

FIG. 16 is a flow chart showing another method for a home wireless switch to select one of a plurality of wireless switches 712, 722, 732, 742 as a new home wireless switch for the first client 702A according to another exemplary embodiment. In this embodiment, the first client 702A sends a DHCP request to the original home wireless switch. The original home wireless switch can then randomly select one of the plurality of wireless switches 712, 722, 732, 742 as a new home wireless switch for the first client 702A.

For example, this random selection can begin a step 1002 where the original home wireless switch hashes a MAC address of the first client 702A and information from the DHCP request to generate a hash value comprising one of a range of values. The range of values comprises a plurality of sub-ranges, and each of the sub-ranges is associated with a particular wireless switch. At step 1004, the original home wireless switch can determine which one of the wireless switches 712, 722, 732, 742 has a sub-range which the hash value is within. In other words, the hash value falls within the sub-range of the selected wireless switch. At step 1006, the original home wireless switch can select the one of the wireless switches 712, 722, 732, 742 having a sub-range which the hash value falls within as the new home wireless switch.

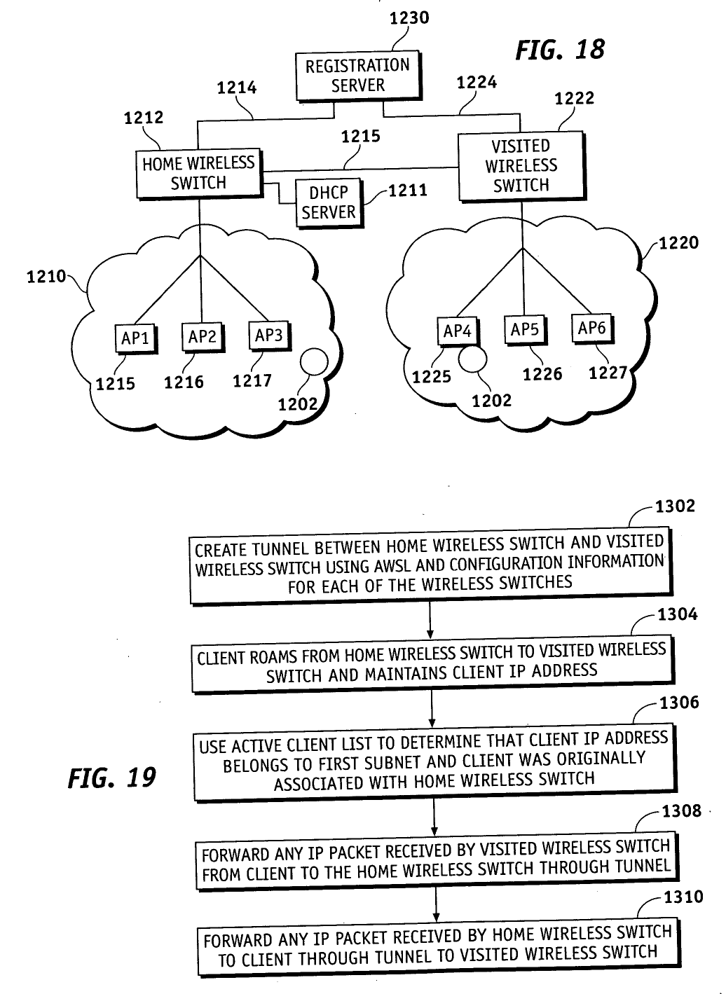

FIG. 18 is a flow chart showing a method for tunneling traffic generated by a first client 702A to a new home wireless switch to according to one exemplary embodiment. Once the new home wireless switch is selected by the original home wireless switch 732, the original home wireless switch 732 forwards the DHCP request to the wireless switch which was selected as the new home wireless switch. At step 1102, a DHCP server 721 assigns an IP address belonging to the selected wireless switch to the first client 702A. At step 1104, the new home wireless switch tunnels a DHCP response from the selected wireless to the original home wireless switch 732 such that the original home wireless switch 732 becomes a new visited wireless switch of the first client 702A and the selected wireless switch becomes the new home wireless switch of the first client 702A. At step 1106, the new visited wireless switch 732 tunnels traffic generated by the first client 702A to the new home wireless switch.

Referring again to FIG. 3, the registration server 730 can include ports 137, a transceiver 131 comprising a transmitter 132 and a receiver 134, a processor 135, and a database 133. In this embodiment, the registration server 730 is configured to assist with load balancing in the WLAN which comprises a plurality of wireless switches 712, 722, 732, 742 configured to support a plurality of client's 702A-702K. Each of the wireless switches generate a traffic load record (TLR). Selected ports 137 couple the registration server 730 to the wireless switches 712, 722, 732, 742 via IP sockets. The receiver 134 can receive the TLRs from each of the wireless switches 712, 722, 732, 742. The processor 135 can create or generate a network load report (NLR) which includes traffic load information for each of the wireless switches 712, 722, 732, 742. The database 135 can store the TLRs for each of the plurality of wireless switches and the NLR, and the transmitter 132 can communicate or send the NLR to each of the wireless switches 712, 722, 732, 742. In one implementation, the wireless switches 712, 722, 732, 742 comprise a original home wireless switch 732 configured as an initial home wireless switch of a first client 702A and a plurality of “candidate” wireless switches 712, 722, 742 which can be selected by the original home wireless switch 732 as a new home wireless switch.

Referring again to FIG. 4, each of the wireless switches 712, 722, 732, 742 of FIG. 13 can be configured as an initial home wireless switch of the first client 702A and can be embodied to include, for example, a number of ports 147, a transceiver 141 including a transmitter 142 and a receiver 144, a processor 145 and a database 143. Processors 145 in each of the wireless switches 712, 722, 732, 742 can be used to monitor traffic being tunneled to and from the respective wireless switches. One of the ports 147 couple the wireless switches 712, 722, 732, 742 of FIG. 13 to the registration server 730 via IP sockets, while other ports 147 are coupled to UDP/IP sockets which couple each of the wireless switches 712-742 to each of the other wireless switches 712-742. The processor 145 of the wireless switch 732 and the other processors 145 in each of the candidate wireless switches 712, 722, 742 can then use this information to generate a traffic load record (TLR), and can use a transmitter 142 to send their respective TLRs to a registration server 730. The registration server 730 can use the TLRs to create or generate a network load report (NLR) which includes traffic load information for each of the wireless switches 712, 722, 732, 742.

The receiver 144 of each of the wireless switches 712, 722, 732, 742 can receive the NLR which includes traffic load information for each of the wireless switches, and the processor 145 of the wireless switch 732 can use the NLR and attributes in the TLRs associated with each of the wireless switches 712, 722, 732, 742, to select one of the candidate wireless switches 712, 722, 742 as a new home wireless switch for the first client 702A. In one implementation, the processor 145 of the wireless switch 732 can select one of the candidate wireless switches 712, 722, 742 as a new home wireless switch when traffic at the original home wireless switch exceeds a predefined traffic load threshold (TLT). In one embodiment, the processor 145 of the wireless switch 732 can determine which one of the candidate wireless switches 712, 722, 742 which is handling the least amount of traffic based on attributes in traffic load records (TLRs) associated with each of the candidate wireless switches 712, 722, 742, and select that candidate wireless switch as the new home wireless switch for the first client.

In other embodiments, the processor 145 of the wireless switch 732 can randomly select one of the wireless switches 712, 722, 732, 742 as a new home wireless switch. For example, to randomly select one of the wireless switches 712, 722, 732, 742 as a new home wireless switch, the processor 145 of the wireless switch 732 can include a hashing module (not shown) and a selector module (not shown). The hashing module can hash a MAC address of the first client and information from the DHCP request to generate a hash value. The hash value can take on a value which falls within a range of values. The hashing module can split the range of values into a plurality of sub-ranges. The processor can randomly assign each of the sub-ranges to a particular wireless switch 712, 722, 732, 742. The selector module can then select one of the candidate wireless switches as a new home wireless switch based on the hash value such that the hash value falls within the sub-range of the one of the wireless switches 712, 722, 732, 742 which is selected as the new home wireless switch for the client 702A.

Each of the wireless switches 712, 722, 732, 742 can be coupled to each of the other wireless switches 712, 722, 732, 742 via a UDP/IP socket. When the first client 702A sends a DHCP request received by the receiver 144 of the wireless switch 732, the transmitter 142 of the wireless switch 732 forwards the DHCP request to the wireless switch selected as the new home wireless switch. When a new client 702B joins the WLAN and sends a DHCP request to the original home wireless switch 732, the processor 145 of the wireless switch 732 redirects a DHCP request received from the new client 702B, and the transmitter 142 of the wireless switch 732 sends the DHCP request to the candidate wireless switch selected as the new home wireless switch. At this point, an IP address belonging to the selected candidate wireless switch is assigned to the client 702A, and the new home wireless switch tunnels a DHCP response to the original home wireless switch 732 such that the original home wireless switch 732 becomes a visited wireless switch of the client 702A and the selected candidate wireless switch becomes the new home wireless switch of the client 702A.

FIG. 19 is a block diagram of a WLAN according to one exemplary embodiment which implements a registration server 1230 and a home wireless switch 1212 supporting a first subnet 1210 and a visited wireless switch 1222 supporting a second subnet 1220. Although FIG. 12 shows two wireless switches 1212, 1222 and two subnets 1210, 1220, it should be appreciated that more than two switches and subnets can be implemented in the WLAN. It should also be appreciated that while FIG. 12 shows a single client 1202, more than one client is typically present in the WLAN. Typically, in a given WLAN there are a number of active clients. In this example, the first subnet 1210 would typically support a group of the active clients having client IP addresses within the first subnet 1210, and the second subnet 1220 would typically supports another group of the active clients having client IP addresses within the second subnet 1220. In addition, in FIG. 12, each subnet 1210, 1220 is shown as comprising three access points (APs) 1215-217 and 1225-227, however, any number of APs could be implemented within a subnet.

As used herein, the terms “access point (AP)” or “access port (AP)” refer to a station that transmits and receives data (sometimes referred to as a transceiver). An access point connects users to other users within the network and also can serve as the point of interconnection between the WLAN and a fixed wire network. Each access point can serve multiple users within a defined network area. As a client moves beyond the range of one access point, the client can be automatically handed over to the next AP. A WLAN may only require a single access point. The number of APs in a given subnet generally increases with the number of network users and the physical size of the network.

The home wireless switch 1212 supports a first VLAN comprising a first subnet 1210 which includes access points (AP1) 1215, (AP2) 1216, and (AP3) 1217. All clients on the first VLAN have IP addresses in the first subnet 1210. Tunnels couple the access points (AP1) 1215, (AP2) 1216, and (AP3) 1217 to the home wireless switch 1212. The home wireless switch 1212 has first configuration information comprising a first IP address and a list of first subnets (IP domains) supported by the home wireless switch 1212. The home wireless switch 1212 registers with the registration server 1230 by communicating the first configuration information to the registration server 1230 over the first IP socket 1214. The client 1202 is initially associated with first subnet 1210 communicating with the home wireless switch 1212 through the AP3 1217. The client 1202 has a client IP address from within the first subnet 1210. The client 1202 eventually roams into the second subnet 1220 where it communicates with the visited virtual wireless switch 1222 through the access port (AP4) 1225.

Similarly, the visited wireless switch 1222 supports a second VLAN comprising a second subnet 1220 which includes access points (AP4) 1225, (AP5) 1226, and (AP6) 1227. All clients on the second VLAN have IP addresses in the second subnet 1220. Tunnels couple the access points (AP4) 1225, (AP5) 1226, and (AP6) 1227to the visited wireless switch 1222. The visited wireless switch 1222 has second configuration information comprising a second IP address and a list of second subnets (IP domains) supported by the visited wireless switch 1222. The visited wireless switch 1222 registers with the registration server 1230 by communicating the second configuration information to the registration server 1230 over the second IP socket 1224.

Because the IP address of the registration server is configured on each of the wireless switches, each of the wireless switches can use the IP address during registration to open an IP socket to the registration server. In this example, a first IP socket 1214 can be provided which couples the home wireless switch 1212 and the registration server 1230, and a second IP socket 1224 between the visited wireless switch 1222 and the registration server 1230.

A database 133 in the registration server 1230 stores the associated configuration information for each of the plurality of wireless switches.

Each of the wireless switches also communicates registration information for each active client to the registration server 1230. The registration server 1230 can use the registration information to create an active client list (ACL). The active client list comprises a record for each active client 1202 in the WLAN. The record of each client 1202 comprises a number of attributes, for instance, a MAC address of the client, a client IP address of the client, a home switch of the client, a visited switch of the client, inactivity timers for the home switch and the visited switch and location information. The registration server 1230 can send a copy of the active client list (or a portion of the active client list) to each wireless switch in the WLAN.

In one embodiment, the registered wireless switches can periodically send updates regarding registration information for each active client to the registration server 1230. The registration server 1230 can use these updates to create an updated active client list. Whenever the registration server 1230 receives updated registration information (or new registration information from a new switch joining the network), the registration server 1230 can then send the updates of the active client list to each wireless switch as the updates are received from the wireless switches.

As will be described below, when the client roams from its original home subnet to a visited subnet supported by a visited wireless switch, the active client list can be used by each of the wireless switches to allow a client to keep its original TCP/IP or UDP/IP connection and its original client IP address assigned by its home wireless switch.

The active client list includes a record for the client 1202 which is based on the first configuration information. This record of comprises a MAC address of the client 1202, the client IP address of the client, the home wireless switch 1212 of the client, the visited wireless switch 1222 of the client 1202, inactivity timers for the home wireless switch 1212 and the visited wireless switch 1222. This record can be periodically updated using updates received from the wireless switch. A database 133 in the registration server 1230 can store the first configuration information, second configuration information, and the active client list.

Because the home wireless switch 1212 and the visited wireless switch 1222 are registered on the registration server 1230, a UDP/IP tunnel 1215 can be created which couples the home wireless switch 1212 and the visited wireless switch 1222. Each of the wireless switches can use configuration information from the wireless switch list to open a UDP/IP tunnel or socket to the other wireless switch. As will be explained in greater detail below, this tunnel allows the client 1202 to maintain the client's IP address from its home wireless switch 1212 when the client 1202 roams from the home wireless switch 1212 and the visited wireless switch 1222.

A protocol can be implemented which allows a DHCP server 1211 to assign the original client IP address to the client even when the client 1202 roams from the home wireless switch 1212 to the visited wireless switch 1222.

When the client 1202 begins to roam to the visited wireless switch 1222, as the client 1202 approaches the visited wireless switch 1222, the client 1202 hears a new beacon sent out by an access port (AP) 1225 connected to the visited wireless switch 1222. The new beacon has a new BSSID (MAC address) different from the one used by access port (AP3) 1217 connected to the home wireless switch 1212. As such, the client 1202 802.11 authenticates with the visited wireless switch 1222, 802.11 associates with the visited wireless switch 1222, 802.1x authenticates with the visited wireless switch 1222 and issues a Dynamic Host Configuration Protocol (DHCP) request. Once the client 1202 802.11 authenticates and 802.11 associates with the visited wireless switch 1222, the client 1202 can continue its existing TCP/IP connection.

To allow for layer 3 roaming between the home wireless switch 1212 and the visited wireless switch 1222, it would be desirable to send a Dynamic Host Configuration Protocol (DHCP) request to the client's home wireless switch 1212 since this can allow the client 1202 to keep its original client IP address. Because the ACL is sent to each wireless switch, each switch has information about all active clients in the network. The visited wireless switch 1222 can obtain the client IP address from the registration information that was sent to the registration server 1230 by the home wireless switch 1212 when the client gets its IP address from the home wireless switch 1212. For example, the visited wireless switch 1222 can search the record of the client 1202 to get the MAC address of the client 1202. The visited wireless switch 1222 can use the MAC address of the client 1202 to determine that the client IP address belongs to the first subnet 1210 and that the client 1202 was originally associated with the home wireless switch 1212. Thus, the visited wireless switch 1222 knows that the client 1202 was initially associated with the home wireless switch 1212 and that it had a client IP address belonging to the first subnet 1210.

The visited wireless switch 1222 can then relays the DHCP request to the home wireless switch 1212 through the tunnel 1215, and the home wireless switch 1212 passes the DHCP request to the DHCP server 1211. The DHCP server 1211 re-assigns the same original client IP address to the client 1202. Because the client 1202 maintains its original client IP address from the home switch, the client 1202 does not need to re-establish its connection. This can prevent the session from dropping. The home wireless switch 1212 forwards a Dynamic Host Configuration Protocol (DHCP) response to the visited wireless switch 1222 and the client 1202.

When the client 1202 sends IP packets to the network, the IP packets will go to the visited wireless switch 1222. The visited wireless switch 1222 can then forward any IP packets it receives through the tunnel 1215 to the home wireless switch 1212 which can forward the IP packets to a router. Likewise, for outbound packets destined to the client IP address, the home wireless switch 1212 can forward the outbound IP packets it receives to the client 1202 through the visited wireless switch 1222.

In one embodiment, if the client 1202 comprises a WPA2 client, then the WPA2 client 1202 is pre-authenticated with the visited wireless switch 1222 to achieve layer 3 mobility with low latency. If the client uses IPSec, terminated on the home switch and no 802.11 encryptions, then the client could 802.11 re-authenticate and search the ACL to get the home wireless switch 1212 from client's MAC address. This can allow all packets from the client 1202 to be forwarded to the home wireless switch 1212. Otherwise the client will 802.11 re-authenticate, go through dot1.x authentication, four way and two handshake to generate new transient keys and then continue with existing TCP or UDP sessions. The dot1.x authentication involves a RADIUS server and the latency can depend on type of the inter-authentication method (PEAP, TTLS, TLS).

FIG. 19 is a flow chart showing an exemplary method for allowing a client 1202, initially associated with a home wireless switch 1212 and having a client IP address from within a first subnet 1210, to roam from the home wireless switch 1212 to a visited wireless switch 1222 configured to support a second subnet 1220 according to one exemplary embodiment. This method can be used, for example, in a WLAN to allow a client 1202 to keep its client IP address and maintain IP connectivity while roaming between the first subnet 1210 and the second subnet 1220.

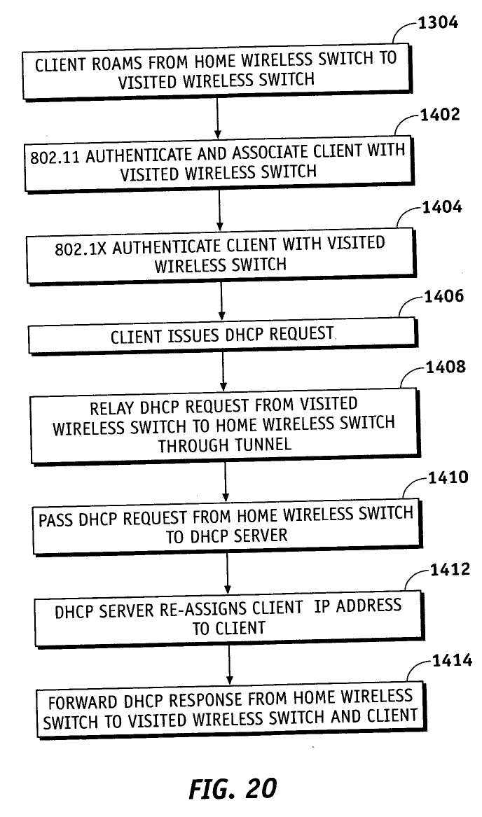

At step 1302, a tunnel is created or opened between the home wireless switch 1212 to the visited wireless switch 1222 by using the AWSL and configuration information for the home wireless switch 1212 to the visited wireless switch 1222. At step 1304, the client 1202 roams from the home wireless switch 1212 to the visited wireless switch 1222. The client 1202 can keep its original client IP address and maintain IP connectivity while roaming from the first subnet 1210 to the second subnet 1220 using techniques which will now be described with reference to FIG. 20.

FIG. 20 is a flow chart showing exemplary message exchanges between the home wireless switch 1212, which supports a first subnet 1210, and the visited wireless switch 1222, which supports a second subnet 1220, to allow the client 1202 to maintain its original client IP address when the client 1202 roams to the second subnet 1220. At step 1402, the client 1202 is 802.11 authenticated and associated with the visited wireless switch 1222, and at step 1404, 802.1x authenticated with the visited wireless switch 1222. At step 1406, the client 1202 issues a Dynamic Host Configuration Protocol (DHCP) request which is relayed, at step 1408, from the visited wireless switch 1222 to the home wireless switch 1212 through the tunnel 1215. At step 1410, the DHCP request can then be passed from the home wireless switch 1212 to the DHCP server 1211. At step 1412, the DHCP server 1211 re-assigns the client IP address to the client, and at step 1414, a Dynamic Host Configuration Protocol (DHCP) response can be forwarded from the home wireless switch 1212 to the visited wireless switch 1222 and the client 1202.

Referring again to FIG. 19, at step 1306, the active client list can be used to determine that the client IP address belongs to the first subnet 1210 and that the client 1202 was originally associated with the home wireless switch 1212. The visited wireless switch 1222 can obtain the client IP address from the registration information sent to the visited wireless switch 1222 by registration server 1230 by the home wireless switch 1212 when the client gets its IP address from the home wireless switch. At step 1308, any IP packet sent from the client 1202 and received by the visited wireless switch 1222 can be forwarded to the home wireless switch 1212 through the tunnel 1215, and, at step 1310, any IP packet received by the home wireless switch 1212 can be forwarded through the tunnel 1215 to the visited wireless switch 1222 which forwards the IP packet to the client 1202.

Referring again to FIG. 3, some of the ports 137 can couple the registration server 130 to the home wireless switch 1212 and the visited wireless switch 1222. The receiver 134 can receive registration information associated with each client from each of the wireless switches. The processor 135 can create an active client list (ACL) using the registration information from each client. The transmitter 132 can send a copy of the ACL to each wireless switch in the WLAN.

Referring again to FIG. 4, one of the ports 147 of the home wireless switch 1212 can be coupled to one of the ports 137 of the visited wireless switch 1212 via the UDP/IP tunnel. To enable the client to maintain the client IP address when the client roams from the home wireless switch 1212 and the visited wireless switch 1222, the client 1202 802.11 authenticates with the visited wireless switch 1222, 802.11 associates with the visited wireless switch 1222, 802.1x authenticates with the visited wireless switch 1222 and issues a Dynamic Host Configuration Protocol (DHCP) request to the visited wireless switch 1222. The receiver 144 of the home wireless switch can receive the DHCP request from the visited wireless switch 122 through the tunnel, and the transmitter 142 of the home wireless switch 1212 can send the DHCP request to a Dynamic Host Configuration Protocol (DHCP) server 1211 which re-assigns the client IP address to the client 1202. The transmitter 142 of the home wireless switch can send a DHCP response to the visited wireless switch and the client. The receiver 144 of the visited wireless switch 1222 can receive the DHCP response from the home wireless switch 1212.

The receiver 144 of the visited wireless switch 1222 can receive an active client list from the registration server 1230, and the processor 145 of the visited wireless switch 1222 can use the active client list to determine that the client IP address belongs to the first subnet 1210 and that the client 1202 was originally associated with the home wireless switch 1212. The processor 145 of the visited wireless switch 1222 obtains the client IP address from the registration information sent to the registration server 1230 by the by the home wireless switch 1212 when the client gets its IP address from the home wireless switch 1212. The processor 145 of the visited wireless switch 1222 can search the record associated with the client 1202 to get the home wireless switch 1212 from the MAC address of the client 1202. The transmitter 142 of the visited wireless switch 1222 can send registration information for each client in the second subnet to the registration server. The receiver 144 of the visited wireless switch 1222 can receive, after the client 1202 has roamed from the home wireless switch 1212 to the visited wireless switch 1222, an IP packet sent from the client 1202. The transmitter 142 of the visited wireless switch 1222 can then send the IP packet through the UDP/IP tunnel to the home wireless switch 1212. The receiver 144 of the home wireless switch can be coupled to the first port and can receive, after the client has roamed from the home wireless switch to the visited wireless switch, an IP packet sent from the visited wireless switch through the UDP/IP tunnel. This IP packet originates at the client.

Another one of the ports 147 can be coupled to the registration server. The receiver 144 of the home wireless switch can receive an active client list from the registration server. The processor 145 of the home wireless switch can use the active client list to determine that the client is now associated with the home wireless switch. The receiver 144 of the home wireless switch can receive a second IP packet addressed to the client. The transmitter 142 of the home wireless switch, which is coupled to the port, can send the second IP packet to the visited wireless switch through the UDP/IP tunnel. The visited wireless switch sends the second IP packet to the client. The receiver 144 of the visited wireless switch 1222 can receive a second IP packet for the client 1202 sent from the home wireless switch 1212 through the UDP/IP tunnel.

Thus, numerous embodiments have been disclosed above which can provide techniques which support layer 3 IP roaming and allow a client to keep its original, pre-roam IP address and TCP/IP connection from its home subnet when the client undergoes a layer 3 roam to a new subnet. These techniques can help reduce the likelihood of dropped calls or sessions without requiring modification to the client software.

Moreover, other embodiments have been disclosed above which can provide techniques which allow for load balancing between wireless switches in a WLAN by allowing a home wireless switch to determine that it no longer needs to support a client when the client moves away from its home switch. In some embodiments, techniques are provided which allow the home switch to determine that it is no longer the best home switch for a particular client.

The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical. Furthermore, numerical ordinals such as “first,” “second,” “third,” etc. simply denote different singles of a plurality and do not imply any order or sequence unless specifically defined by the claim language.

Furthermore, words such as “connect” or “coupled to” used in describing a relationship between different elements do not imply that a direct physical connection must be made between these elements. For example, two elements may be connected to each other physically, electronically, logically, or in any other manner, through one or more additional elements, without departing from the scope of the invention. Thus, to the extent the description refers to certain features being “connected” or “coupled” together, unless expressly stated otherwise, “connected” or “coupled” means that one feature is directly or indirectly connected or coupled to another feature, and not necessarily mechanically. Although drawings depict exemplary arrangements of elements, additional intervening elements, devices, features, or components may be present in an actual embodiment assuming that the functionality of the circuit is not adversely affected. The connecting lines shown in the various figures represent example functional relationships and/or physical couplings between the various elements. Many alternative or additional functional relationships or physical connections may be present in a practical embodiment or implementation.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific. integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should also be understood that various changes can be made in the function and arrangement of elements without departing from the scope of the invention as set forth in the appended claims and the legal equivalents thereof. Thus, the present invention is not intended to be limited to the embodiments shown herein but is to be accorded the widest scope consistent with the principles and novel features disclosed herein.

What is claimed is:

1. A registration server for use in a wireless network comprising a plurality of wireless clients, a plurality of IP tunnels and a plurality of wireless switches each being configured to support a particular subnet and communicate with the registration server over one of the IP tunnels, comprising:
a receiver configured to receive, from one of the wireless switches, a Dynamic Host Configuration Protocol (DHCP) request for an Internet Protocol (IP) address originating from one of the wireless clients associated with the subnet of that wireless switch; and
an IP address assignment module hosted at the registration server and configured to assign IP addresses to the wireless clients of the wireless network.

2. A registration server of claim 1, wherein the IP address assignment module is configured to generate a pool of IP addresses, wherein the pool of IP addresses comprises a plurality of sub-pools of IP addresses, wherein each sub-pool includes IP addresses supported by one of the subnets in the wireless network.

3. A registration server of claim 1, wherein the IP address assignment module is configured to assign an IP address to a given wireless client from the sub-pool associated with the particular subnet the given wireless client is associated with, wherein the IP address assigned to the given wireless client is associated with the particular subnet for that given wireless client.

4. A registration server of claim 1, further comprising:
an IP address management module configured to manage the pool of IP addresses for all wireless clients in the wireless network.

5. A registration server of claim 1, wherein the IP address assignment module receives a registration packet comprising an IP tunnel header and wireless client registration information.

6. A registration server of claim 5, wherein the IP address assignment module comprises:
a dedicated DHCP server module configured to assign an IP address to a given wireless client from the sub-pool associated with the particular subnet the given wireless client is associated with, wherein the IP address assigned to the given wireless client is associated with the particular subnet for that given wireless client, wherein the registration packet further comprises the DHCP request from the wireless client encapsulated in the registration packet.

7. A registration server of claim 1, wherein the registration server adds the wireless client registration information into an Active Wireless client List (ACL), and assigns home and visited wireless switches to the wireless client based on the wireless client registration information, wherein the wireless client registration information comprises the wireless client Media Access Control (MAC) address, and an Extended Service Set Identifier (ESSID).

8. A registration server of claim 6, wherein the IP address assignment module is configured to generate a registration response packet in response to the DHCP request, wherein the registration response packet comprises an IP tunnel header and registration information which comprises a wireless client IP address assigned to the wireless client, a home wireless switch assigned to the wireless client and a visited wireless switch assigned to the wireless client.

9. A registration server of claim 8, wherein the IP address assignment module comprises:
a DHCP relay module configured to generate a DHCP registration response packet in response to the DHCP request, wherein each DHCP registration response packet comprises the IP tunnel header, the registration information about the wireless client, and a DHCP response encapsulated within the DHCP registration response packet by the IP tunnel header and the registration information,
wherein the DHCP relay module of the registration server is configured to tunnel the DHCP registration response packet to wireless switch which initially communicated the registration packet to the registration server.

10. A wireless switch configured to support a first subnet and configured for use in a wireless network comprising a plurality of wireless clients, a registration server configured to assign IP addresses to the wireless clients, a plurality of IP tunnels and a plurality of wireless switches each being configured to support a particular subnet and communicate with the registration server over one of the IP tunnels, comprising:
a receiver configured to a Dynamic Host Configuration Protocol (DHCP) request for an Internet Protocol (IP) address from a wireless client associated with the first subnet; and
a DHCP proxy module configured to use the DHCP request to determine the MAC address of the wireless client, and determine if the wireless switch already has a record for the wireless client based on the MAC address of that wireless client, wherein the record includes authentication and association information associated with the wireless client.

11. A wireless switch of claim 10, further comprising:
a transmitter configured to transmit the DHCP request to the registration server over one of the IP tunnels if the wireless switch does not have a record for the wireless client.

12. A wireless switch of claim 11, if the wireless switch does not have a record for the wireless client, wherein the wireless switch generates a registration packet and sends the registration packet to the registration server, wherein the registration packet comprises: an IP tunnel header for sending the registration packet to the registration server, and wireless client registration information associated with the wireless client.

13. A wireless switch of claim 11, if the wireless switch has a record for the wireless client, wherein the transmitter returns a DHCP response to the wireless client which assigns the existing IP address of the wireless client to the wireless client.

14. A wireless switch of claim 12, wherein the registration packet further comprises the DHCP request from the wireless client encapsulated in the registration packet.

15. A wireless switch of claim 12, wherein the wireless client registration information comprises the wireless client Media Access Control (MAC) address, an Extended Service Set Identifier (ESSID), the type of encryption being used, and the type of authentication being used.

16. A wireless switch of claim 15, wherein the receiver is configured to receive a registration response packet from the registration server, wherein the registration response packet comprises an IP tunnel header, a DHCP response, and registration information about the wireless client assigned by the registration server, and
wherein the wireless switch further comprises:
a processor configured to determine the IP address of the wireless client based on the DHCP response.

17. A wireless switch of claim 16, wherein the wireless switch is configured to receive a registration response packet in response to the DHCP request, wherein the registration response packet comprises the IP tunnel header, the registration information about the wireless client, and a DHCP response encapsulated within the registration response packet by the IP tunnel header and the registration information about the wireless client.

18. A wireless switch of claim 17, wherein the registration information comprises a wireless client IP address assigned to the wireless client, a home wireless switch assigned to the wireless client, and a visited wireless switch assigned to the wireless client, and wherein the transmitter is configured to transmit at least part of the registration information to the wireless client.

19. A wireless network, comprising:
a plurality of wireless clients, wherein each wireless client is configured to generate a Dynamic Host Configuration Protocol (DHCP) request for an Internet Protocol (IP) address;
a plurality of IP tunnels;
a registration server;
a plurality of wireless switches each being configured to support a particular subnet and communicate with the registration server over one of the IP tunnels, wherein each wireless switch is configured to receive the DHCP requests from wireless clients associated with the subnet of the wireless switch, and forward the DHCP requests from wireless clients associated with that subnet; and
wherein the registration server is configured to receive the forwarded DHCP requests, and assign IP addresses to the wireless clients based on the forwarded DHCP requests.

20. A wireless network of claim 19, further comprising:
a plurality of DHCP servers each being coupled to one of the wireless switches, wherein each DHCP server is configured to receive DHCP requests from wired clients within a subnet of its corresponding wireless switch and configured to assign IP addresses to wired clients supported by a corresponding wireless switch of the DHCP server.

21. A wireless network of claim 19, wherein the registration server comprises:
an IP address assignment module hosted at the registration server and configured to assign IP addresses, from a pool of IP addresses, to the wireless clients of the wireless network; and
an IP address management module configured to manage the pool of IP addresses for all wireless clients in the wireless network.

22. A wireless network of claim 21, wherein the IP address assignment module is configured to generate the pool of IP addresses from a plurality of sub-pools of IP addresses, wherein each sub-pool includes IP addresses supported by one of the subnets in the wireless network.

23. A wireless network of claim 22, wherein the IP address assignment module is configured to assign an IP address to a given wireless client from the sub-pool associated with the particular subnet the given wireless client is associated with, wherein the IP address assigned to the given wireless client is associated with the particular subnet for that given wireless client.

24. A wireless network of claim 22, wherein the plurality of wireless switches comprise a first wireless switch which supports a first subnet and a second wireless switch which supports a second subnet, and wherein the pool of IP addresses comprises:
a first sub-pool of IP addresses associated with the first wireless switch and the first subnet; and
a second sub-pool of IP addresses associated with the second wireless switch and the second subnet.

25. A wireless network of claim 21, wherein the IP address assignment module is configured to generate a table comprising a plurality of entries, where each entry of the table comprises: a wireless switch IP address and a sub-pool of IP addresses corresponding to the wireless switch IP address.

26. A wireless network of claim 19, when a wireless client roams from a first wireless switch to a second wireless switch, wherein the wireless client sends the DHCP request to the second wireless switch, and wherein the second wireless switch comprises:
a DHCP proxy module configured to use the DHCP request to determine the MAC address of the wireless client, and determine if the second wireless switch already has a record for the wireless client based on the MAC address of that wireless client, wherein the record includes authentication and association information associated with the wireless client.

27. A wireless network of claim 26, if the DHCP proxy module determines that the second wireless switch already has a record for the wireless client, the second wireless switch sends a DHCP response back to the wireless client which assigns the existing IP address of the wireless client to the wireless client.

28. A wireless network of claim 27, if the DHCP proxy module determines that the second wireless switch does not have a record for the wireless client, wherein the second wireless switch registers the wireless client with the registration server by generating a registration packet and sending the registration packet to the registration server, wherein the registration packet comprises:
an IP tunnel header for sending the registration packet to the registration server; and
wireless client registration information associated with the wireless client, wherein the wireless client registration information is collected during 802.11 authentication/association and 802.1x authentication of the wireless client.

29. A wireless network of claim 28, wherein the IP address assignment module comprises:
a dedicated DHCP server module hosted on the registration server and configured to assign an IP address to a given wireless client from the sub-pool associated with the particular subnet the given wireless client is associated with, wherein the IP address assigned to the given wireless client is associated with the particular subnet for that given wireless client, and
wherein the registration packet further comprises the DHCP request from the wireless client encapsulated in the registration packet.

30. A wireless network of claim 29, wherein the registration server adds the wireless client registration information into an Active Client List (ACL), and assigns home and visited wireless switches to the wireless client based on the wireless client registration information.

31. A wireless network of claim 30, wherein the wireless client registration information comprises the wireless client's Media Access Control (MAC) address.

32. A wireless network of claim 24, wherein the IP address assignment module determines an IP address of the first wireless switch and assigns a particular IP address to the wireless client from the second sub-pool of IP addresses associated with the second wireless switch and the second subnet.

33. A wireless network of claim 29, wherein the IP address assignment module generates a registration response packet in response to the DHCP request and sends each registration response packet to the wireless switch which initially communicated the registration packet to the registration server, wherein the registration response packet comprises an IP tunnel header and registration information about the wireless client assigned by the registration server, and
wherein the second wireless switch determines the IP address of the wireless client based on the DHCP response.

34. A wireless network of claim 33, wherein each registration response packet comprises an IP tunnel header and registration information which comprises a wireless client IP address assigned to the wireless client by the registration server, a home wireless switch assigned to the wireless client by the registration server, and a visited wireless switch assigned to the wireless client by the registration server.

35. A wireless network of claim 29, wherein the IP address assignment module generates a DHCP registration response packet in response to the DHCP request, wherein each DHCP registration response packet comprises the IP tunnel header, the registration information about the wireless client, and a DHCP response encapsulated within the DHCP registration response packet by the IP tunnel header and the registration information,
wherein the DHCP registration response packet is tunneled to the wireless switch which initially communicated the registration packet to the registration server.

36. A wireless network of claim 35, wherein the registration information comprises a wireless client IP address assigned to the wireless client, a home wireless switch assigned to the wireless client, and a visited wireless switch assigned to the wireless client, and wherein the wireless switch is configured to transmit at least part of the registration information to the wireless client.
